(19) United States
(12) Patent Application Publication
(10) Pub. No.: US 2005/0170214 A1
(43) Pub. Date: Aug. 4, 2005

(54) Magnetic recording medium and method for producing the same

(75) Inventors: Tsugihiro Doi, Osaka (JP); Tetsutaro Inoue, Osaka (JP); Hisanobu Mikamo, Osaka (JP); Seigi Kawarai, Osaka (JP); Sadamu Kuse, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD., Osaka (JP)

(21) Appl. No.: 10/995,314

(22) Filed: Nov. 24, 2004

(30) Foreign Application Priority Data
Nov. 27, 2003 (JP) P2003-397718

(51) Int. Cl. G11B 5/68

(52) U.S. Cl. 428/694 BP; 428/694 BR

(57) ABSTRACT

There is provided a magnetic recording medium comprising a flexible non-magnetic substrate, and a magnetic layer containing magnetic particles, formed on at least one surface of the flexible non-magnetic substrate, and this magnetic recording medium is characterized in that an uppermost layer formed on the side of the magnetic layer is a non-magnetic layer with a thickness of 1 to 50 nm, which contains a resin and has a surface roughness (P-V) of 2 to 20 nm. This magnetic recording medium is excellent in high density recording performance, and is highly reliable in durability.

### FIELD OF THE INVENTION

The present invention relates to magnetic recording media excellent in high density recording performance, and the manufacturing thereof.

### BACKGROUND OF THE INVENTION

Magnetic recording media have found a variety of applications in audio tapes, video tapes, computer tapes, magnetic discs, magnetic cards, etc. Particularly in the field of data backup tapes, magnetic tapes having memory capacities of 200 GB or more per reel have been commercialized in association with the tendency of the mass storages of hard discs for backup, and a mass storage backup tape having a memory capacity of exceeding 1 TB has been proposed. Under these circumstances, magnetic recording media having far higher density recording performance will be indispensable in future.

In the manufacturing of magnetic tapes capable of corresponding to such high density recording, highly advanced techniques are employed to manufacture fine magnetic powder (hereinafter referred to as magnetic particles), to fill coating layers with such magnetic powder at higher densities, to smoothen coating layers and to form still thinner magnetic layers.

Regarding the improvement of the magnetic powder, trials to reduce the sizes of magnetic particles and simultaneously improve the magnetic characteristics thereof have been made in order to record signals with shorter wavelengths. For this improvement, needle-shaped metallic magnetic particles with an average particle size of 100 nm or less are proposed. To prevent a decrease in output from a magnetic tape due to demagnetization in association with the recording of signals with short wavelengths, trials to manufacture magnetic tapes having higher coercive forces have been more vigorously made in these years.

The technical innovation of magnetic heads has made it possible to record data on magnetic tapes having high coercive forces. Especially in the lengthwise recording system, the coercive force of a magnetic tape is preferably as high as possible within a range in which the deletion of recorded data by a magnetic head is possible, in order to prevent a decrease in output from the magnetic tape due to demagnetization in association with the recording and reproducing of data. Accordingly, a practical and effective method for improving the recording density of a magnetic tape is to enhance the coercive force of the magnetic tape.

On the other hand, the improvement of the manufacturing technology for magnetic recording media confronts some difficulties. In association with the high density recording of data on magnetic media, the wavelengths of signals of data to be recorded become shorter and shorter. When the magnetic layer of a magnetic medium is thick, the influences of loss due to self demagnetization during the recording/reproducing of data and loss due to the thickness of the magnetic layer become more serious, although such influences hitherto have not been so seriously taken. Therefore, the reduction of the thickness of the magnetic layers of magnetic media is urgently needed.

However, there is a problem in that, when the thickness of a magnetic layer is reduced, the surface roughness of a non-magnetic substrate gives an adverse influence on the surface of the magnetic layer and degrades the properties of the surface of the magnetic layer. When the thickness of a single magnetic layer alone is reduced, a method of decreasing the solid content of a magnetic coating composition or a method of decreasing the amount of the magnetic coating composition to be applied is considered. However, these methods are not effective to eliminate the defects of a coating layer or to increase the amount of magnetic particles for filling the magnetic layer, which leads to less strength of the coating layer. For this reason, to reduce the thickness of a magnetic layer by improving the manufacturing technology for media, a so-called concurrent layer-superposing system is proposed. In this system, a non-magnetic primer layer (hereinafter referred to as a primer layer) is provided between a non-magnetic substrate and a magnetic layer, and the upper magnetic layer is applied while the non-magnetic primer layer is being wet (cf. JP-A-5-197946).

As the wavelengths of signals to be recorded becomes shorter and shorter, and as a magnetic layer becomes thinner and thinner, leakage flux from the magnetic layer becomes very weak. In the systems of this type using magnetic recording media comprising such magnetic layers, highly sensitive magnetoresistance heads (including GMR type) (hereinafter referred to as MR heads) are dominantly used as reproducing heads. The MR heads have no induction coil and therefore cause less mechanical noises, which leads to a higher C/N ratio, since noises from the magnetic recording media can be lessened.

However, the MR heads have a disadvantage in that even the minute unevenness of the surfaces of magnetic layers, which causes few problems in the magnetic induction type heads, gives serious influences on reproduced outputs from the MR heads. Therefore, more careful attentions are needed to control the surface roughness of the magnetic layers. While non-magnetic particles are contained in the magnetic layers in order to improve the durability of the magnetic layers (cf. JP-A-5-197946 and JP-A-11-238226), the non-magnetic particles, undesirably, disorder the orientation of magnetic particles or degrade the surface smoothness of the magnetic layers, as the thickness of the magnetic layers becomes thinner and thinner, and consequently hinder the improvement of recording density.

The foregoing efforts to improve the recording density contribute much to the improvement of the linear recording density of the recording media (i.e., the recording density of tapes in the lengthwise direction). However, increasing the recording density of magnetic recording media in the widthwise direction by decreasing the widths of the track pitches is also important in order to improve the recording density of the recording media. The narrower track pitches induces the need of a system in which servo tracks are provided on the recording media so that a reproducing head can correctly trace the data tracks. The servo tracks thus provided make it possible for the reproducing head to correctly move on the data tracks. However, the fluctuation in the distance between the servo tracks and the data tracks due to changes in temperature and humidity makes it impossible for the reproducing head to correctly move on the data tracks. As a result, the reproducing head is off from the tracks (i.e., off-track), which leads to a lower reproducing output level and to more errors.

For this reason, it is important that the recording media comprising servo systems should have dimensional stability in the widthwise directions. Many trials have been made to provide recording media having high dimensional stability in the widthwise directions and methods for manufacturing the same (cf., JP-A-11-250499, JP-A-10-231371 and JP-A-2002-329312). Further trials are made to provide coating type protective layers on magnetic layers so as to improve the durability of the magnetic layers or for the decorative purposes (cf., JP-A-5-266461, JP-A-8-138242 and JP-A-7-320253).

The magnetic recording media disclosed in the publications of JP-A-5-197946 and JP-A-11-238226 are hard to achieve sufficient electromagnetic conversion, when the wavelengths of signals to be recorded are shorter or when the thickness of the magnetic layers are thinner, because non-magnetic particles are contained in the magnetic layers of these media. The publication of JP-A-11-250449 discloses a magnetic tape having a thermal expansion coefficient of 0.0015%/° C. or less and a humidity expansion coefficient of 0.0015%/% RH or less in the widthwise direction. However, this publication does not specifically teaches what kinds of constitutive components should be selected in order to obtain such a magnetic tape having the above dimensional stability in the widthwise direction. The publications of JP-A-10-231371 and JP-A-2002-329312 disclose substrates which are useful to obtain magnetic recording media having high dimensional stability in the widthwise directions. However, the magnetic recording medium of JP-A-10-231371 is insufficient in the dimensional stability in the widthwise direction, and the magnetic recording medium of JP-A-2002-329312 suffers from poor productivity and high cost, because a metalized film is provided on the substrate. The publication of JP-A-5-266461 discloses a magnetic recording medium which comprises a magnetic layer composed of a continuous thin film of a ferromagnetic metal or an alloy thereof, and which has features in that a lubricating layer (or a protective layer) containing soccer ball-shaped three-dimensional carbon molecules C60 (fullerene) is provided on the magnetic layer. However, it is hard to obtain sufficient electromagnetic conversion from this magnetic recording medium when signals with short wavelengths are recorded, because the protective layer contains relatively large particles with an average particle size of several μm which cause a large spacing between the magnetic layer and the magnetic head. The publication of JP-A-8-138242 discloses a magnetic recording medium comprising a hard substrate, a magnetic layer formed on the substrate, and a coating layer which is directly formed on the magnetic layer by applying a coating composition for non-magnetic coating layer and drying the same. However, this magnetic recording medium is mainly used as a magnetic card, and the magnetic layer has a thickness of 10 μm and the non-magnetic coating layer has a thickness of 1 μm or more. Therefore, this magnetic recording medium can not achieve such electromagnetic conversion that a high density recording medium of the present invention which comprises a flexible substrate and a magnetic layer formed thereon is intended to attain.

The publication of JA-A-7-320253 discloses a magnetic recording medium which comprises a magnetic layer containing magnetic particles and a binder resin, and a resin layer containing a lubricant, formed on the surface of the magnetic layer. The intention of forming the resin layer is to prevent the migration of the lower molecular weight components of the binder resin contained in the magnetic composition for the magnetic layer, to the surface of the magnetic layer, and to prevent the sticking of such components thereto or to prevent the drop-out of such components therefrom. This intention is different from the intention of the present invention which is to smooth the surface of the non-magnetic layer to thereby reduce the spacing, so as to improve the performance of recording signals with short wavelengths and simultaneously to improve the durability of the magnetic layer. Therefore, the magnetic recording medium of this publication is insufficient in the performance of recording signal with short wavelengths. In addition, the resin layer is not cross-linked and cured, and thus is insufficient in durability. The resin layer disclosed is formed by forming and drying the magnetic layer, and providing the resin layer thereon. According to the present inventers' investigation, this method permits the resin layer to be absorbed into the magnetic layer, and makes it hard for the resin layer to be independently formed on the magnetic layer. Such a resin layer can not have sufficient durability. As described above, the foregoing prior arts are insufficient to achieve high density recording on the magnetic recording media.

### SUMMARY OF THE INVENTION

An object of the present invention is to provide a magnetic recording medium, e.g., a magnetic tape, having high density recording performance which permits mass storage of 1 TB or more per reel, and also having highly reliable durability.

As shown in FIG. 1 or 2, a magnetic recording medium (1) of the present invention comprises a flexible non-magnetic substrate (2) and a magnetic layer (3) containing magnetic particles, formed on at least one surface of the substrate (2), and is characterized in that a non-magnetic layer (4) which contains a resin and has a thickness of 1 to 50 nm and a surface roughness (P-V) of 2 to 20 nm is formed on the side of the magnetic layer (3) as an uppermost layer.

The resin in the non-magnetic layer (4) may contain a radiation-curable resin or an organic-inorganic compound resin.

A non-magnetic primer layer (5) containing non-magnetic particles may be provided between the magnetic layer (3) and the flexible non-magnetic substrate (2). In this case, the thickness of the magnetic layer (3) is preferably 0.01 to 0.2 μm. The thickness of the non-magnetic layer (5) is preferably 0.2 to 1.5 μm.

The average particle size of the magnetic particles in the magnetic layer (3) is preferably 5 to 100 nm. The coercive force of the magnetic layer (3) is preferably 100 to 320 kA/m.

The present invention also provides a process for manufacturing the magnetic recording medium (1) which comprises the flexible non-magnetic substrate (2) and the magnetic layer (3) containing magnetic particles, formed on at least one surface of the flexible non-magnetic substrate (2), and this process includes a step of forming the non-magnetic layer (4) as the uppermost layer on the side of the magnetic layer (3), by applying a non-magnetic coating composition. The non-magnetic layer (4) contains a resin and has a thickness of 1 to 50 nm.

The non-magnetic layer (4) and/or the magnetic layer (3) may be formed with at least one sliding coater.

As a method for controlling the surface roughness (P-V) of the non-magnetic layer (4) to 2 to 20 nm, the following means can be employed. (1) No filler is contained in the magnetic layer (3). (2) As the magnetic particles to be contained in the magnetic layer (3), fine magnetic particles, in particular, substantially globular magnetic particles with a particle size of 5 to 30 nm are used. (3) As a filler to be contained in the magnetic layer (3), filler particles which have substantially the same shape as that of the magnetic particles, and preferably which have a particle size substantially equal to or smaller than the particle size of the magnetic particles are used. (4) The non-magnetic layer (4) which is a resin layer is formed on the magnetic layer (3) by the wet-on-wet method: for example, in case of the magnetic recording medium shown in FIG. 1, the primer layer (5), the magnetic layer (3) and the non-magnetic layer (4) are formed by the wet-on-wet method so as to retard the drying of these layers. (5) The non-magnetic primer layer (5) is formed between the magnetic layer (3) and the flexible non-magnetic substrate (2). (6) The non-magnetic primer layer (5) containing plate-shaped non-magnetic particles is formed between the magnetic layer (3) and the flexible non-magnetic substrate (2).

The passage, “no filler is contained in the magnetic layer (3)” as the means (1) indicates that the magnetic layer (3) contains substantially no filler or may contain such a negligibly small amount of filler (1 wt. % or less of the weight of the whole powder) that does not disorder the orientation of the particles.

The surface roughness (P-V) of the non-magnetic layer (4) can be controlled by employing any of the means (1) to (6) or by employing two or more of the means (1) to (6) in combination, to thereby improve the durability of the magnetic recording medium and concurrently to improve the performance of recording signals with short wavelengths.

### BRIEF DESCRIPTION OF THE DRAWINGS

FIG. 1 is a longitudinal sectional view of a magnetic recording medium according to an embodiment of the present invention.

FIG. 2 is a longitudinal sectional view of a magnetic recording medium according to another embodiment of the present invention.

FIG. 3 is a graph showing a relationship between the thickness of a magnetic layer, and the still durability and the C/N ratio of a magnetic tape.

FIG. 4 is a graph showing a relationship between a resin to be used in a magnetic layer, and the still durability and the C/N ratio of a magnetic tape.

FIG. 5 is a graph showing a relationship between the thickness of a magnetic layer, and the still durability and the C/N ratio of a magnetic tape.

FIG. 6 is a graph showing a relationship between the thickness of a primer layer, and the still durability and the C/N ratio of a magnetic tape.

FIG. 7 is a graph showing a relationship between the average particle size of magnetic particles, and the still durability and the C/N ratio of a magnetic tape.

FIG. 8 is a graph showing a relationship between the surface roughness (a P-V value) of a non-magnetic layer, and the still durability and the C/N ratio of a magnetic tape.

### DETAILED DESCRIPTION OF THE INVENTION

Hereinafter, the present invention will be described in more detail by way of the means (1) of controlling the surface roughness (P-V) of the non-magnetic layer (4) to 2 to 20 nm out of the means (1) to (6), namely, “the case of the magnetic layer (3) containing no filler”.

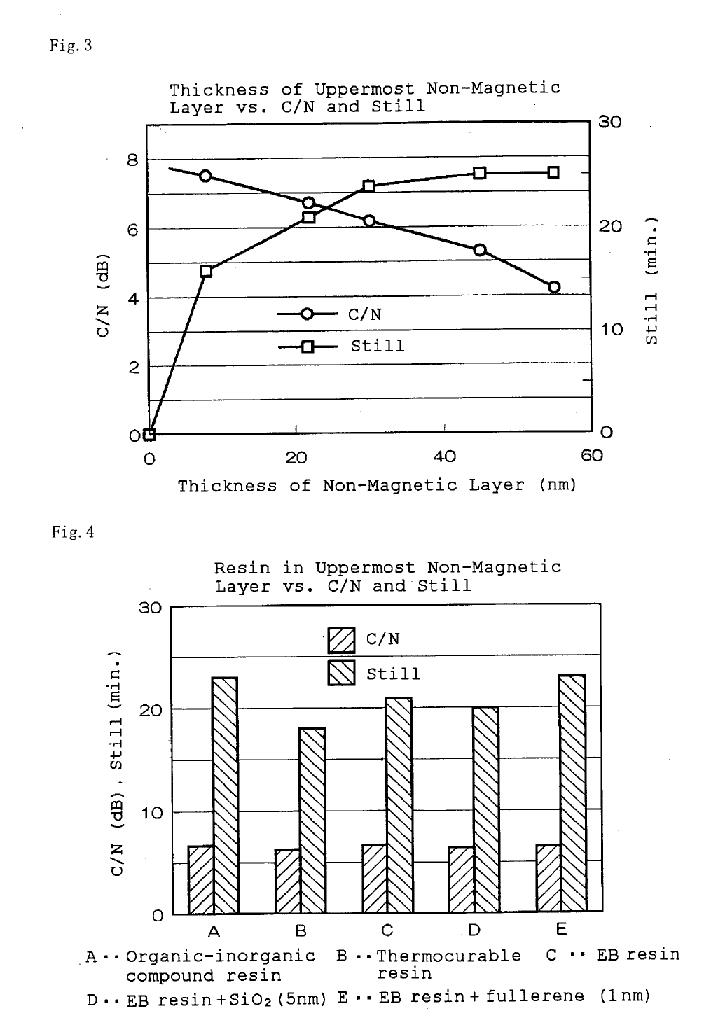

The thickness of the non-magnetic layer (4) is generally 1 to 50 nm, preferably 5 to 30 nm. When this thickness is less than 1 nm, the effect of improving the durability of a magnetic tape can not be sufficiently obtained. When the thickness exceeds 50 nm, the effect of improving the durability is saturated, and the spacing between the magnetic head and the magnetic layer (3) becomes too large, which leads to a more decrease in the performance of recording signals with short wavelengths (see FIG. 3).

The surface roughness (P-V) of the non-magnetic layer (4) is generally 2 to 20 nm, preferably 3 to 15 nm, more preferably 5 to 12 nm. When the surface roughness (P-V) is less than 2 nm, the effect of improving the durability of a magnetic tape can not be sufficiently obtained. When the surface roughness (P-V) exceeds 20 nm, the effect of improving the durability is saturated, and the spacing between the magnetic head and the magnetic layer (3) becomes too large, which leads to a more decrease in the performance of recording signals with short wavelengths (see FIG. 8).

When the resin in the non-magnetic layer (4) contains a radiation-curable resin, the thin non-magnetic layer (4) can be formed at high productivity. Otherwise, the resin in the non-magnetic layer (4) may contain an organic-inorganic compound resin having a siloxane modified site in the molecule. Such an organic-inorganic compound resin has high abrasion resistance (see FIG. 4).

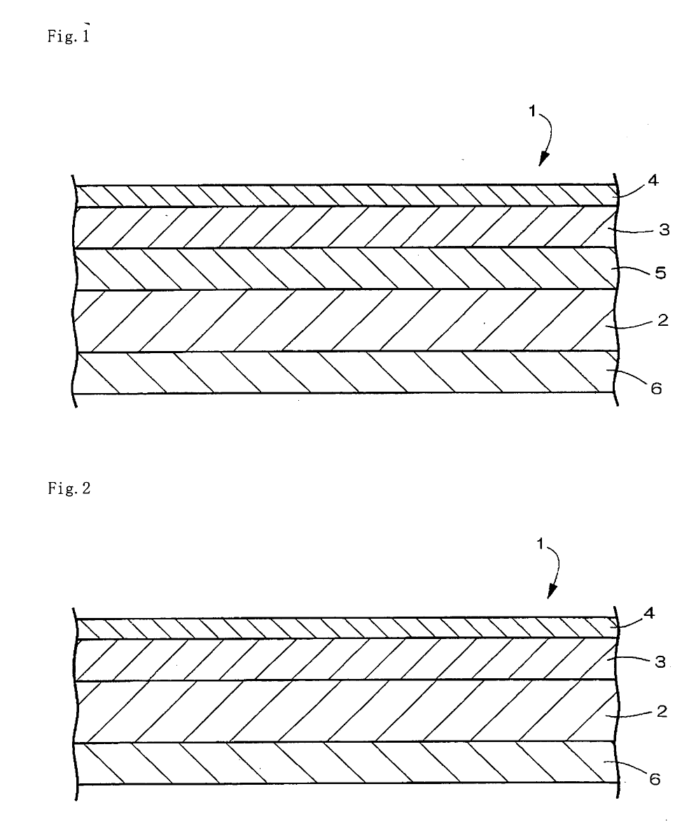

When the non-magnetic primer layer (5) containing non-magnetic particles is provided between the magnetic layer (3) and the flexible non-magnetic substrate (2) as shown in FIG. 1, unevenness in the thickness of the magnetic layer (3) can be suppressed, and thus, the magnetic layer (3) with an uniform thickness can be accurately formed.

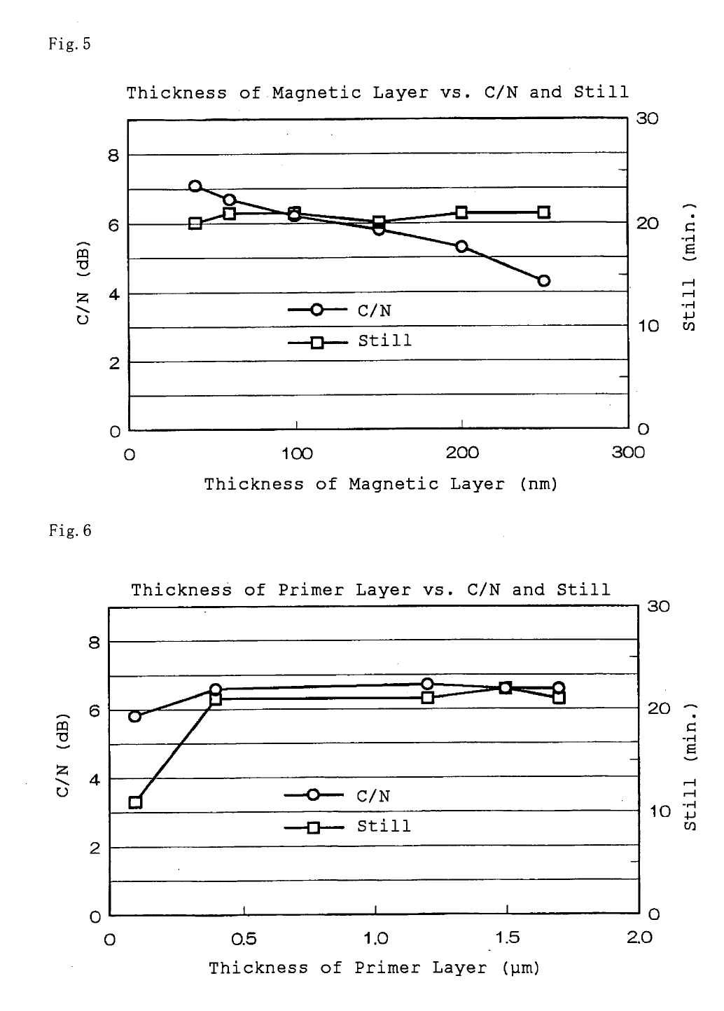

In this case, the thickness of the magnetic layer (3) is preferably 0.01 to 0.2 μm (10 to 200 nm), more preferably 0.01 to 0.1 μm (10 to 100 nm). When this thickness is less than 0.01 μm (10 nm), the resultant output is small, and it becomes hard to form an uniform magnetic layer (3) by coating. When the thickness exceeds 0.2 μm (200 nm), the losses due to self demagnetization and thickness tend to be larger when signals with short wavelengths are recorded or reproduced (see FIG. 5).

The thickness of the non-magnetic primer layer (5) is preferably 0.2 to 1.5 μm. When the thickness is less than 0.2 μm, the effect of reducing unevenness in the thickness of the magnetic layer (3) and the effect of improving the durability are not sufficiently obtained. When the thickness exceeds 1.5 μm, the total thickness of the magnetic recording medium (1) is too large. When such a thick magnetic recording medium is applied to a magnetic tape, the memory capacity per one reel of such a tape becomes smaller (see FIG. 6).

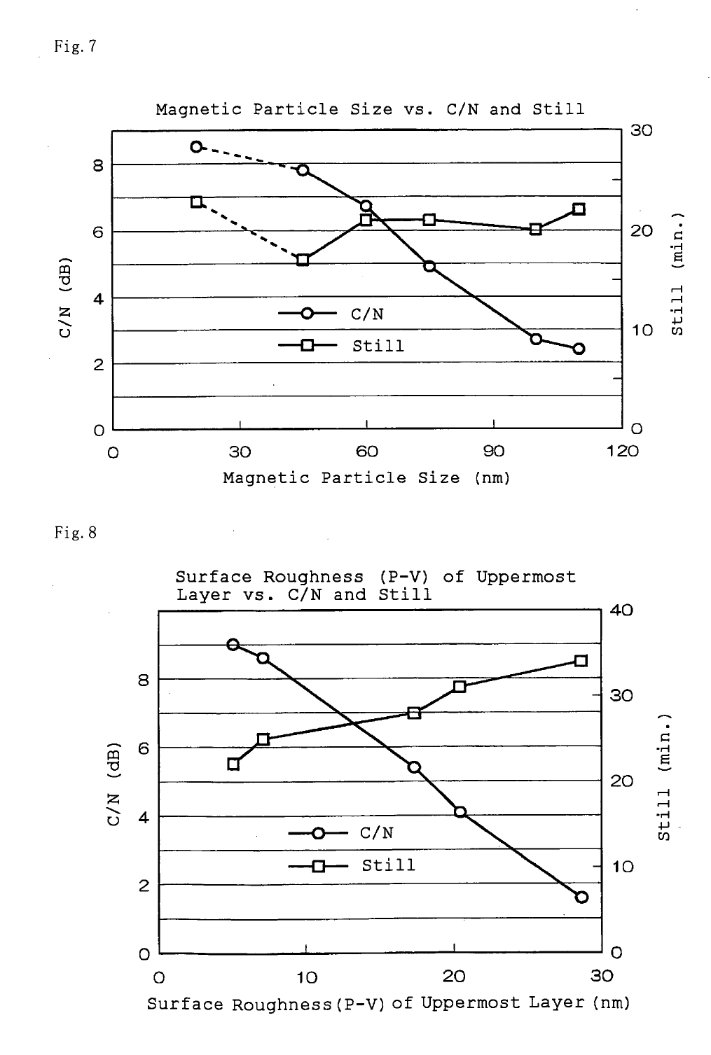

The average particle size of the magnetic particles contained in the magnetic layer (3) shown in FIG. 1 is preferably 5 to 100 nm. When the average particle size is less than 5 nm, the surface energies of the particles become larger, and such particles are hard to disperse. When the average particle size exceeds 100 nm, noises from the medium become larger (see FIG. 7).

The coercive force of the magnetic layer (3) is preferably 100 to 320 kA/m. When the coercive force is less than 100 kA/m, a decrease in output from the medium occurs due to demagnetization attributed to a demagnetic field, when signals with short wavelengths are recorded. When the coercive force exceeds 320 kA/m, recording signals with a magnetic head becomes difficult.

When a back layer (6) containing non-magnetic particles is provided on the other surface of the flexible non-magnetic substrate (2) opposite the magnetic layer as shown in FIG. 1 or 2, the running performance of the tape is improved.

In general, the magnetic layer contains additives such as abrasive particles and carbon black particles so as to improve the durability and running performance of the magnetic layer. In many cases, these abrasive particles and carbon black particles have larger particle sizes than the minor axes of the magnetic particles in order to exhibit the above effects. For this reason, the surface of the magnetic layer unavoidably becomes rough. If this magnetic layer is formed as the uppermost layer, the spacing between such a magnetic layer and a magnetic head becomes larger, which leads to a decrease in the performance of recording signals with short wavelengths. Further, the abrasive particles and the carbon black particles disorder the orientation of the magnetic particles in the magnetic layer, and the magnetic characteristics of the medium unavoidably degrade. Also for this reason, the performance of recording signals with short wavelengths degrades. Furthermore, theses particles are non-magnetic particles, and therefore, the magnetization of the magnetic layer per unit volume decreases, which leads to a decrease in reproducing output. For the foregoing reasons, it is a subject matter to improve the durability and running performance of a magnetic recording medium by another method while the amounts of the above non-magnetic particles in the magnetic layer are decreased as much as possible, to thereby develop a high density recording medium capable of corresponding to mass storage of, for example, 1 TB per one reel of a tape.

The present inventors have accomplished the present invention based on a finding that this problem can be solved by providing the non-magnetic layer (4) which contains a resin as a main component, as the upper most layer, on the side of the magnetic layer (3) of the magnetic recording medium (1) which has the magnetic layer (3) containing magnetic particles, formed on at least one surface of the flexible non-magnetic substrate (2) as shown in FIG. 1 or 2. That is, the durability of the magnetic layer (3) is improved by providing the non-magnetic layer (4) containing a resin, as the uppermost layer of the magnetic recording medium (1), and such improved durability of the magnetic layer (3) leads to the improved reliability of the magnetic recording medium (1). Further, the formation of the non-magnetic layer (4) is effective to prevent that unavoidable decrease in the recording performance relative to signals with short wavelengths, which is attributed to a larger spacing between a magnetic head and a magnetic layer which hitherto has been formed as an uppermost layer. Furthermore, it is no need to contain non-magnetic particles such as a filler in the magnetic layer (3), and thus, the percentage of the magnetic particles contained in the magnetic layer (3) can be increased, which leads to improved magnetization per unit volume of the magnetic layer (3). Consequently, the resultant magnetic recording medium (1) can have high density recording performance.

As mentioned above, the thickness of the non-magnetic layer (4) is generally 1 to 50 nm. When the thickness of the non-magnetic layer (4) is less than 1 nm, the durability of the magnetic layer is not sufficiently improved. When it exceeds 50 nm, the effect of improving the durability is saturated, and the spacing between the magnetic head and the magnetic layer (3) becomes too large, which degrades the recording performance relative to signals with short wavelengths.

In the present invention, the thickness of the non-magnetic layer (4) is specifically measured by the following method.

Firstly, the magnetic recording medium (1) as a sample is embedded in a resin, and the embedded magnetic recording medium (1) is cut out with a focusing ion beam processing machine, and ten visual fields of the section of the magnetic medium are photographed using a transmission electron microscope (TEM) of a magnification of 10,000. Then, the surface of the non-magnetic layer (4) as the uppermost layer, and the interface between the non-magnetic layer (4) and the magnetic layer (3) on each photograph are bordered. Next, five points on each visual field of the photograph are optionally selected (total fifty points), and the distance between each of the bordered lines is measured as the thickness of the non-magnetic layer (4) at such five points. This operation is repeated, and the average of the resultant distances is determined as the thickness of the non-magnetic layer (4).

The center line average height Ra of the non-magnetic layer (4) is preferably 0.2 to 2.0 nm, more preferably 0.3 to 1.5 nm, most preferably 0.5 to 1.3 nm. The peak-to-valley value P-V of the non-magnetic layer (4) is preferably 2 to 20 nm, more preferably 3 to 15 nm, most preferably 5 to 12 nm. When the value Ra is smaller than the lower limit, the running of the magnetic tape becomes unstable. When this value exceeds the upper limit, the resolution of data of short wavelength signals becomes poor or the output decreases due to the spacing loss, which results in a higher error rate.

The surface roughness of the uppermost layer is measured with AFM (Dimension 3000 manufactured by Digital Instruments Co., Ltd.). The measurement is made on ten points in a visual field of 5 μm×5 μm (square), in a tapping mode. The maximum value and the minimum value are excluded from the measured data, and the average of the remaining data is calculated.

The resin to be contained in the non-magnetic layer (4) is preferably a highly abrasion resistant resin, and may be any of the known resins, in so far as this requirement is satisfied.

To stably form a thin coating layer with a thickness of 50 nm or less (i.e., the non-magnetic layer (4)), the molecular weight (weight-average molecular weight) of the above resin is preferably 10,000 or less, more preferably 5,000 or less, most preferably 2,000 or less. To form a hard coating layer from such a low molecular weight resin, a curing agent is used. Preferably, a radiation-curable resin is used as such a resin, and is cured by radioactive rays such as electron beams, ultra violet or the like. An organic-inorganic compound resin having a siloxane-modified site in the molecule is preferred because of its high abrasion resistance. The siloxane-modified site herein referred to is a group represented by the formula: —(SiR₁R₂—O)ₙ—R₃ in which R₁, R₂ and R₃ are each a substituent such as a hydrogen atom, a halogen atom, an alkyl group or an alkoxy group.

Examples of the resin include cellulose resins, ether resins, phenol resins, carbonate resins, epoxy resins, urethane resins, amide resins and imide resins. Preferably, each of the above resins which has an introduced aromatic ring therein is used, or each of the above resins is used in combination with a corresponding curing agent (e.g., an isocyanate, amine or the like) in order to improve the abrasion resistance. Such a resin is acrylicly modified to form a radiation-curable resin having a radiosensitive double bond. The details of the radiation-curable resin will be described later.

Examples of the organic-inorganic compound resin include siloxane modified polyurethane resins, siloxane modified epoxy resins, siloxane modified polyamidoimide resins, siloxane modified polyimide resins and the like. The content of Si (converted in the terms of SiO₂) in the organic-inorganic compound resin is preferably 2 to 50 wt. % based on the weight of the solid content of the resin.

The non-magnetic layer (4) is provided as described above, to thereby improve not only the durability of the magnetic recording medium (1) but also the dimensional stability of the magnetic recording medium (1) in the widthwise direction against a change in humidity. In general, the humidity expansion coefficients of the magnetic layer (3) and the primer layer (5), described later, of the magnetic recording medium (1) are larger than that of the flexible non-magnetic substrate (2), because the humidity expansion coefficients of binder resins used in the magnetic layer (3) and the primer layer (5) are larger than that of the non-magnetic substrate. The magnetic layer (3) and the primer layer (5) have 10 to 30 vol.% of voids when viewed in the order of microns, and such voids tend to absorb vapor. Thus, the dimensions of the magnetic layer (3) and the primer layer (5) largely change under the influence of a change in humidity.

To overcome this disadvantage, a dense resin layer (i.e., the non-magnetic layer (4)) is provided as an uppermost layer as in the present invention. By doing so, the influence of a change in humidity is lessened, and the dimensional stability of the medium against a change in humidity can be improved.

The non-magnetic layer (4) contains the above resin as the main component, and if needed, non-magnetic particles. In this case, the use of non-magnetic particles having a particle size sufficiently smaller than the thickness of the non-magnetic layer (4), namely, having an average particle size of not larger than a half of the thickness of the layer, is preferred. Preferably, the non-magnetic particles to be used are as relatively hard as a Mohs' hardness of 4 or more. For example, inorganic oxide particles such as silica and alumina, hard carbon particles such as fullerene and carbon nanotubes, and the like can be used.

The non-magnetic layer (4) is preferably a continuous layer. However, if the thickness thereof is thin, such a thin non-magnetic layer (4) sometimes can not be formed over a whole of the surface of the magnetic layer (3). In this case, the non-magnetic layer (4) in discrete states or in a holed state is formed on the magnetic layer (3). In other words, the non-magnetic layer (4) may be partially discontinuous, and such a partially discontinuous non-magnetic layer (4) may be formed on the magnetic layer (3). That is, the non-magnetic layer (4) in discrete states or in a holed state is allowed, in so far as such a non-magnetic layer (4) can exhibit the effect of improving the durability of the magnetic layer (3). Such non-magnetic layers are also included in the scope of “the non-magnetic layer (4)” of the present invention.

The magnetic recording medium (1) of the present invention comprises the non-magnetic substrate (2), and the magnetic layer (3) and the non-magnetic layer (4) formed in this order on the non-magnetic substrate (2) as shown in FIG. 2. Other than that, the magnetic recording medium (1) of the present invention may be of a multi-layer type, comprising the non-magnetic substrate (2), and the non-magnetic primer layer (5), the magnetic layer (3) and the non-magnetic layer (4) formed in this order on the non-magnetic substrate (2), as shown in FIG. 1.

These layers (3), (4) and (5) are formed with any of the known coating apparatuses such as a gravure coater, knife coater, extrusion coater, slide coater, curtain coater, spray coater, kiss coater or the like. Each of the above coaters may be used alone or in combination to concurrently or sequentially form these layers (3), (4) and (5). Each of the layers (3), (4) and (5) may be formed while the underlying layer is wet or after the underlying layer is dried and further smoothened with a calender.

Next, the components of the magnetic recording medium (1) of the present invention are described in more detail.

Flexible Non-Magnetic Substrate (2)

The thickness of the flexible non-magnetic substrate (2) (hereinafter referred to as a non-magnetic substrate) may be varied depending on the end use, and it is generally 1.5 to 100 μm. Particularly when used in the form of a tape, it is 1.5 to 11.0 μm, more preferably 2.0 to 7.0 μm. When this thickness is less than 1.5 μm, the formation of such a thin film is difficult, and the film has lower strength. When the thickness exceeds 11.0 μm, the total thickness of the tape becomes large, which leads to less memory capacity per one reel of the tape. When the magnetic recording medium (1) is formed in the shape of a disc, the thickness of the non-magnetic substrate (2) is preferably 20 to 80 μm.

The Young's modulus of the non-magnetic substrate (2) in the lengthwise direction is preferably 5.8 GPa (590 kg/mm²) or more, more preferably 7.1 GPa (720 kg/mm²) or more. When this Young's modulus is less than 5.8 GPa (590 kg/mm²), the running of the tape becomes unstable. In the helical scanning type, the ratio of the Young's modulus (MD) of the non-magnetic substrate in the lengthwise direction/ the Young's modulus (TD) of the substrate in the widthwise direction is preferably 0.60 to 0.80, more preferably 0.65 to 0.75. When this ratio is less than 0.60, or when it is more than 0.80, flatness of output from the magnetic head between the entrance to the tracks and the exit therefrom sometimes becomes larger. This flatness becomes minimum when this ratio is around 0.70. In the linear recording type, the ratio of the Young's modulus of the substrate in the lengthwise direction/ the Young's modulus of the substrate in the widthwise direction is preferably 0.70 to 1.30.

The thermal expansion coefficient of the non-magnetic substrate (2) in the widthwise direction is preferably (−10 to 10)×10⁻⁶, and the humidity expansion coefficient thereof in the widthwise direction is preferably 0 to 10×10⁻⁶. When the thermal expansion coefficient or the humidity expansion coefficient in the widthwise direction is outside the above range, off-track occurs due to a change in temperature or humidity, which leads to a higher error rate.

Specific examples of the non-magnetic substrate (2) which satisfy the above properties include biaxial oriented polyethylene terephthalate films, polyehtylene naphthalate films, aromatic polyamide films, aromatic polyimide films and the like.

Primer Layer (5)

Preferably, the non-magnetic primer layer (5) is provided between the magnetic layer (3) and the non-magnetic substrate (2) as shown in FIG. 1, when the magnetic layer (3) is formed with a thickness of 0.2 μm or less, in order to improve the short wavelength signal-recording performance of the magnetic recording medium (1).

The thickness of the primer layer (5) is preferably 0.2 to 1.5 μm, more preferably 1.0 μm or less, particularly 0.8 μm or less. When this thickness is less than 0.2 μm, the effect of decreasing the fluctuation of the thickness of the magnetic layer (3) and the effect of improving the durability thereof are poor. When this thickness exceeds 1.5 μm, the total thickness of the tape becomes too large, which leads to a less memory capacity per one reel of the tape.

As the non-magnetic particles to be used in the primer layer (5), there are given titanium oxide, iron oxide, aluminum oxide and the like. Preferably used is iron oxide alone or a mixture of iron oxide and aluminum oxide. The non-magnetic particles may be any of globular particles, plate-shaped particles, needle-shaped particles and fusiform particles. Preferably, the needle-shaped particles or the fusiform particles have major axes of 20 to 200 nm, and minor axes of 5 to 200 nm. In many cases, the primer layer contains the non-magnetic particles as a main component, and if needed, carbon black particles with a particle size of 0.01 to 0.1 μm and aluminum oxide particles with a particle size of 0.05 to 0.5 μm as adjuvants. To apply the primer layer (5) smoothly without any variation in thickness, the use of the non-magnetic particles and the carbon black particles as mentioned above, both of which have sharp particle size distributions, is particularly preferred.

Preferably, non-magnetic plate-shaped particles with an average particle size of 10 to 100 nm are added to the primer layer (5). As the components of the non-magnetic plate-shaped particles, rare earth elements such as cerium, and oxides or compound oxides of zirconium, silicon, titanium, manganese, iron and the like are used. To improve the electric conductivity of the primer layer, plate-shaped carbon particles such as graphite with an average particle size of 10 to 100 nm, or plate-shaped ITO (indium-tin compound oxide) particles with an average particle size of 10 to 100 nm may be added. The addition of the above non-magnetic plate-shaped particles is effective to improve the uniformity of the thickness, surface smoothness, rigidity and dimensional stability of the layer. The binder resin to be used in the primer layer (5) may be the same one as that used in the magnetic layer (3).

Lubricant

Preferably, 0.5 to 5.0 wt. % of a higher fatty acid and 0.2 to 3.0 wt. % of a higher fatty acid ester are contained in the primer layer, based on the weight of whole particles in the magnetic layer (3) and the primer layer (5). By doing so, a lubricant can migrate to the non-magnetic layer (4) through the magnetic layer (3) so that the friction coefficient of the magnetic medium against a head becomes smaller. When the amount of the higher fatty acid added is less than 0.5 wt. %, the amount of the lubricant migrated to the non-magnetic layer (4) is small, and therefore, the effect of decreasing the friction coefficient is poor. When it exceeds 5.0 wt. %, the primer layer is plasticized, and thus, the primer layer may lose toughness. When the amount of the higher fatty acid ester added is less than 0.2 wt. %, the effect of decreasing the friction coefficient is poor. When it exceeds 3.0 wt. %, the lubricant excessively migrates to the non-magnetic layer (4) through the magnetic layer (3), which may induce an adverse side effect that the tape sticks to the head.

As the higher fatty acid, a fatty acid having 10 or more carbon atoms is preferably used. As the higher fatty acid ester, an ester of the above higher fatty acid is preferably used. The fatty acid having 10 or more carbon atoms may be in the form of a linear chain or a branched chain, or may be a cis form isomer or a trans form isomer. Preferably, a linear fatty acid having high lubricity is used. Examples of such a fatty acid include lauric acid, myristic acid, stearic acid, palmitic acid, behenic acid, oleic acid, linoric acid and the like. Among them, myristic acid, stearic acid and palmitic acid are preferred. The amount of the fatty acid to be added to the magnetic layer (3) is not particularly limited, since the fatty acid migrates between the primer layer (5) and the magnetic layer (3). The total amount of the fatty acids added to the magnetic layer (3) and the primer layer (5) is adjusted to the above specified amount. When the fatty acid is added to the primer layer (5), the addition of the fatty acid to the magnetic layer (3) is not always needed.

When the magnetic layer (3) contains 0.5 to 3.0 wt. % of a fatty acid amide and 0.2 to 3.0 wt. % of a higher fatty acid ester based on the weight of the magnetic particles, the lubricant migrates to the non-magnetic layer (4). As a result, the friction coefficient of the tape against the head becomes smaller while the tape is being run. When the amount of the fatty acid amide added to the magnetic layer is less than 0.5 wt. %, the amount of the lubricant migrated to the non-magnetic layer (4) is small, and the direct contact at the interface between the head and the non-magnetic layer tends to occur, and thus, a seizure-preventive effect is poor. When this amount exceeds 3.0 wt. %, the lubricant bleeds out to the non-magnetic layer (4), which may cause defects such as drop-out.

As the fatty acid amide, the amides of fatty acids each having 10 or more carbon atoms, such as plamitic acid and stearic acid can be used.

When the amount of the higher fatty acid ester added to the magnetic layer (3) is less than 0.2 wt. %, the amount of the lubricant migrated to the non-magnetic layer (4) is small, and consequently, the friction coefficient-decreasing effect is poor. When this amount exceeds 3.0 wt. %, the lubricant excessively migrates to the non-magnetic layer (4), which may induce an adverse side effect that the tape may stick to the head. In this regard, the intermigration of the lubricants of the magnetic layer (3) and the primer layer (5) is allowed.

In general, the non-magnetic layer (4) contains no lubricant, since the lubricants of the magnetic layer (3) and the primer layer (5) migrate thereto. If needed, the lubricant the same as those of the magnetic layer (3) and the primer layer (5) may be contained in the non-magnetic layer (4).

When the magnetic recording medium of the present invention is shaped in the form of a disc, the total amount of the lubricants to be used is 0.1 to 50 wt. %, preferably 2 to 25 wt. % based on the weight of the ferromagnetic particles of the magnetic layer (3) or the non-magnetic particles of the primer layer (5).

Dispersant

The non-magnetic particles, carbon black particles and magnetic particles contained in the primer layer (5), the magnetic layer (3) and the non-magnetic layer (4) may be surface-treated with any of the known dispersants, for example, fatty acids each having 12 to 18 carbon atoms (RCOOH in which R is an alkyl group having 11 to 17 carbon atoms, or an alkenyl group) such as caprylic acid, capric acid, lauric acid, myristic acid, palmitic acid, stearic acid, behenic acid, oleic acid, eladic acid, linoleic acid, linolenic acid and stearolic acid; a metal soap formed of a salt of an alkaline metal or an alkaline earth metal with any of the above fatty acids; compounds containing fluorine atoms of the above fatty acid esters; the amides of the above fatty acids; polyalkylene oxide alkylphosphate; lecithin; trialkylpolyolefinoxy quaternary ammonium salt (in which alkyl has 1 to 5 carbon atoms, and olefin is ethylene, propylene or the like); sulfate; and copper phthalocyanine and the like. Otherwise, the coating compositions may be prepared using such dispersants. Each of the dispersants may be used alone or in combination. In general, the dispersant is added in an amount of 0.5 to 20 wt. parts to any of the layers, per 100 wt. parts of the binder.

Magnetic Layer (3)

Preferably, the thickness of the magnetic layer (3) is 0.01 to 3.5 μm. When this thickness is less than 0.01 μm, the resultant output from the tape is small, and it is difficult to form the magnetic layer with an uniform thickness. When this thickness exceeds 3.5 μm, the total thickness of the tape becomes too large, which leads to a less memory capacity per one reel of the tape.

To further improve the short wavelength signal-recording performance, the primer layer (5) is provided between the magnetic layer (3) and the non-magnetic substrate (2), and the thickness of the magnetic layer (3) is adjusted to 0.01 to 0.2 μm. The thickness of the magnetic layer (3) is more preferably 0.01 to 0.1 μm, most preferably 0.01 to 0.06 μm.

To increase the memory capacity of the magnetic recording medium (1), magnetic layers (3) may be formed on both surfaces of the non-magnetic substrate (2).

The coercive force of the magnetic layer (3) is preferably 100 to 320 kA/m, more preferably 150 to 320 kA/m, most preferably 200 to 320 kA/m. When the coercive force is less than 100 kA/m, an output from the tape decreases due to demagnetization in a demagnetic field, when signals with shorter wavelengths are recorded. When it exceeds 320 kA/m, recording signals with a magnetic head becomes difficult.

As the binder resin to be used in the magnetic layer (3) (as well as the primer layer (5)), there is used a polyurethane resin in combination with at least one selected from the group consisting of vinyl chloride resins, vinyl chloride-vinyl acetate copolymer resins, vinyl chloride-vinyl alcohol copolymer resins, vinyl chloride-vinyl acetate-vinyl alcohol copolymer resins, vinyl chloride-vinyl acetate-maleic anhydride copolymer resins, vinyl chloride-hydroxyl-containing alkyl acrylate copolymer resins and cellulose resins such as nitrocellulose. Above all, the combination of a polyurethane resin with a vinyl chloride-hydroxyl-containing alkyl acrylate copolymer resin is preferred. Examples of the polyurethane resin include polyester-polyurethane resins, polyether-polyurethane resins, polyether-polyester-polyurethane resins, polycarbonate-polyurethane resins and polyester-polycarbonate-polyurethane resins.

As the binder resin, there is used an urethane resin which comprises a polymer having a functional group such as —COOH, —SO₃M, —OSO₃M, —P═O(OM)₃, —O—P═O(OM)₂ [in which M is a hydrogen atom, an alkali metal base or an amine salt], —OH, —NR¹R², —N⁺R³R⁴R⁵ [in which each of R¹, R², R³, R⁴ and R⁵ is independently a hydrogen atom or hydrocarbon group], or an epoxy group. The use of the above binder resin is effective to improve the dispersibility of the magnetic particles and the like, as mentioned above. When two or more of the above resins are used in combination, it is preferable to use the resins which have functional groups of the same poles to each other, particularly —SO₃M groups.

The binder resin is used in an amount of 7 to 50 wt. parts, preferably 10 to 35 wt. parts, per 100 wt. parts of the magnetic particles. Most preferably, 5 to 30 wt. parts of a vinyl chloride resin and 2 to 20 wt. parts of a polyurethane resin are used in combination as the binder resin.

Preferably, the binder resin is used in combination with a thermocurable crosslinking agent which is bonded to the functional group of the binder resin to thereby crosslink the binder resin. Preferred examples of the crosslinking agent include a variety of polyisocyanates such as tolylenediisocyanate, hexamethylenediisocyanate, isophoronediisocyanate, reaction products of these isocyanates with compounds having a plurality of hydroxyl groups such as trimethtlolpropane and the like, condensates of these isocyanates, and the like. The crosslinking agent is used in an amount of generally 1 to 30 wt. parts, preferably 5 to 20 wt. parts per 100 wt. parts of the binder resin. When the magnetic layer (3) is formed on the primer layer (5) by the wet-on-wet method, some of the polyisocyanate of the primer layer is spread and supplied to the magnetic layer. Therefore, the magnetic layer (3) is crosslinked to some degree, even if the polyisocyanate is not used in combination with the binder resin.

Preferably, a radiation-curable resin is used as a part or a whole of the thermocurable binder resin. As the radiation-curable resin, the above thermocurable resin which is acrylic modified to have a radiosensitive double bond, an acrylic monomer or an acrylic oligomer is used.

As the radiation-curable resin for use as the binder resin for curing the coating layers of the magnetic tape (i.e., the magnetic layer (3), the primer layer (5) and a backcoat layer as will be described later), any of the known radiation-curable resins may be used. The binder resins comprising the known radiation-curable resins are classified as follows.
(1) A thermoplastic resin+a radiation-curable resin (a monomer)
(2) A thermoplastic resin+a radiation-curable resin (a polymer or an oligomer)
(3) A thermoplastic resin+a radiation-curable resin (a monomer)+a radiation-curable resin (a polymer or an oligomer)
(4) A radiation-curable resin (a monomer)
(5) A radiation-curable resin (a polymer or an oligomer)
(6) A radiation-curable resin (a monomer)+a radioactive curable resin (a polymer or an oligomer)

The methods of using these binder resins are specifically carried out, respectively. Preferably, the method is optionally selected according to the requirements for the magnetic tape. For example, the methods of using the binder resins (1) to (3) make it possible to use a variety of thermoplastic resins very excellent in dispersibility relative to magnetic particles and non-magnetic particles, and thus facilitate the designing of the magnetic layer (3) excellent in recording/reproducing performance. However, the binder resins (1) to (3) have the following problem. When the binder resin is cured by irradiation with radioactive rays, an intermolecular crosslinked net work is formed in the radiation-curable resin, and the coating layer is cured by such a net work. However, no crosslinked net work is formed between the molecules of the thermoplastic resin and the radiation-curable resin. Thus, a whole of the resins in the coating layer are not linked through such net works. To design a coating layer having high durability, more researches are needed to select the binder resin, the lubricant and the non-magnetic particles.

In any of the methods of using the binder resins (4) to (6), a radiation-curable resin alone is fully used as the binder resin. Accordingly, crosslinked networks can be formed among all the molecules of the resin. Therefore, these methods facilitate the designing of a coating layer excellent in durability. However, there is a problem in that the kinds of the radiation-curable resins excellent in dispersibility relative to magnetic particles and non-magnetic particles are insufficient. To design a magnetic layer excellent in recording/reproducing performance, more researches are needed for the surface treatment of magnetic particles and the method of dispersing the same.

Generally used as the radiation-curable resin are acrylic acid esters, acryl amides, methacrylates, methacrylic acid amides, ally compounds, vinyl ethers and vinyl esters, each of which has at least two radiosensitive double bonds in the molecule, and the use of a radiation-curable resin having such double bonds each of which has a weight-average molecular weight of 50 to 4,000 is preferable.

Examples of the radiation-curable resin include monomer acrylates (or methacrylates), for example, bifunctional acrylates such as 1,3-butanediol diacrylate, 1,4-butanediol diacrylate, 1,6-hexanediol diacrylate, ethyleneglycol diacrylate, diethyleneglycol diacrylate, triethyleneglycol diacrylate, tetraethyleneglycol diacrylate, polyethyleneglycol diacrylate, propyleneglycol diacrylate, dipropyleneglycol diacrylate, tripropyleneglycol diacrylate, ethoxidized bisphenol A diacrylate, novolak diacrylate and propoxidized neopentylglycol diacrylate, and bifunctional methacrylates analogous to the above acrylates; trifunctional acrylates such as tris(2-hydroxyethyl)isocyanurate triacrylate, trimethylolpropane triacrylate, ethoxidized trimethylolpropne triacrylate, pentaerythritol triacrylate, propoxidized trimethylolpropane triacrylate, propoxidized glyceryl triacrylate and caprolactam-modified trimethylolpropane triacrylate, and trifunctional methacrylates analogous to the above acrylates; tetra- or poly-functional acrylates such as pentaerythritol tetraacrylate, ditrimethylolpropane tetraacrylate, ethoxidized pentaerythritol tetraacrylate, dipenta erythritolhydroxy pentaacrylate and dipentaerythritol hexaacrylate, and tetra- or poly-functional methacrylates analogous to the above acrylates; and oligomers or polymers which have backbones of ether, ester, carbonate, epoxy, vinyl chloride, urethane or the like, and which are modified with the above monomers to have radiosensitive double bonds. Examples of the polymer having radiosensitive double bonds include radiation-curable vinyl chloride copolymers (TB0246 manufactured by TOYOBO CO., LTD.) (polymerization degree=300, and polar group: —OSO₃K=1.5 per molecule), and radiation-curable polyurethane resins (TB0242 manufactured by TOYOBO CO., LTD.) (Mn=25,000, and polar group: phosphorous compound=one per molecule).

The average particle size of the magnetic particles in the magnetic layer (3) shown in FIG. 1 is preferably 5 to 100 nm, more preferably 5 to 60 nm. When this average particle size is less than 5 nm, the surface energy of the particles becomes larger, which makes it hard to disperse the particles. When it exceeds 100 nm, noises become larger. As the magnetic particles, ferromagnetic iron-based metal magnetic particles, iron nitride magnetic particles and plate-shaped hexagonal crystalline Ba-ferrite magnetic particles are preferable.

Each of the ferromagnetic iron-based metal magnetic particles may contain a transition metal such as Mn, Zn, Ni, Cu, Co or the like as a component of an alloy. Above all, Co and Ni are preferred, and Co is particularly preferred since the use of Co is most effective to improve the saturation magnetization. The amount of the transition metal element is preferably 5 to 50 at. %, more preferably 10 to 30 at. % based on the amount of iron. Further, at least one rare earth element selected from yttrium, cerium, ytterbium, cesium, praseodymium, samarium, lantern, europium, neodymium, terbium and the like may be added to prevent the sintering of the magnetic particles. Preferably, cerium, neodymium, samarium, terbium or yttrium is used, since the use thereof is effective to obtain a higher coercive force. The amount of the rare earth element is 0.2 to 20 at %, preferably 0.3 to 15 at %, more preferably 0.5 to 12 at % based on the amount of iron.

The use of the known iron nitride magnetic particles each having an iron nitride phase as a core portion is possible (cf., W003/079333). The particle size of the iron nitride magnetic particles is preferably 5 to 30 nm, more preferably 10 to 20 nm. The core portion of each magnetic particle mainly comprises a Fe₁₆N₂ phase, or a Fe₁₆N₂ phase and an α-Fe phase, and the content of nitrogen is preferably 1.0 to 20 at % based on the amount of iron. A part of iron (40 at % or less) may be substituted by other transition metal element. However, the addition of an excess of cobalt requires more time in the nitriding reaction. For this reason, the amount of cobalt is preferably 10 at % or less. When the outer layer portion of each magnetic particle is coated with 0.05 to 20 at %, preferably 0.2 to 20 at % of a rare earth element based on the amount of iron, and/or Al and Si elements, the coercive force of the magnetic layer becomes as high as 200 kA/m (2,512 Oe) or more, and the resultant magnetic particles are chemically stable fine magnetic particles having a BET specific surface area of 40 to 100 m²/g. Further, the saturation magnetization of the magnetic particles can be controlled to 80 to 160 Am²/kg (80 to 160 emu/g) by coating each of the magnetic particles with a rare earth element and subjecting the coated magnetic particles to an oxidation-stabilizing treatment. Thus, iron nitride magnetic particles having excellent dispersibility in a coating composition and excellent oxidation stability can be obtained. The iron nitride magnetic particles are particularly preferred, because, even if such magnetic particles are globular or ellipsoidal ultrafine particles having a particle size of 50 nm or less and an axial ratio of 1 to 2, a coercive force as high as 200 kA/m (2,512 Oe) or more can be obtained. The needle-shaped magnetic particles are also possible. In this case, the particle size normalized by the major axis is preferably 30 to 100 nm, more preferably 30 to 60 nm.

The coercive forces of the ferromagnetic iron-based metal magnetic particles and the iron nitride magnetic particles are preferably 100 to 320 kA/m, and the saturation magnetization thereof is preferably 80 to 200 Am²/kg (80 to 200 emu/g), more preferably 100 to 180 Am²/kg (100 to 180 emu/g).

The average particle sizes of the ferromagnetic iron-based metal magnetic particles and the iron nitride magnetic particles are preferably 5 to 100 nm, more preferably 5 to 60 nm. When this average particle size is less than 5 nm, the coercive force decreases, or the surface energy of the particles increases, which leads to difficulties of dispersing the magnetic particles in a coating composition. When it exceeds 100 nm, particle noises attributed to the size of the particles become larger. The BET specific surface area of the ferromagnetic particles is preferably 35 m²/g or more, more preferably 40 m²/g or more, most preferably 50 m²/g or more. It is generally 100 m²/g or less.

The above ferromagnetic iron-based metal magnetic particles and the above iron nitride magnetic particles may be surface-treated with Al, Si, P, Y or Zr, or an oxide thereof.

The coercive force of the hexagonal crystalline Ba-ferrite magnetic particles is preferably 120 to 320 kA/m, and the saturation magnetization thereof is preferably 40 to 70 Am²/kg (40 to 70 emu/g). The particle size (the dimension in the plate face direction) thereof is preferably 10 to 50 nm, more preferably 10 to 30 nm, particularly 10 to 20 nm. When the particle size is less than 10 nm, the surface energy of the particles increases, which makes it hard to disperse the magnetic particles in a coating composition. When it exceeds 50 nm, the particle noises attributed to the size of the particles become larger. The aspect ratio of such a particle (i.e., the plate size/the thickness of the plate) is preferably 2 to 10, more preferably 2 to 5, particularly 2 to 4. The BET specific surface area of the hexagonal crystalline Ba-ferrite magnetic particles is preferably 1 to 100 m²/g.

The above magnetic properties of the ferromagnetic particles are measured with a vibrating sample magnetometer in an external magnetic field of 1,273.3 kA/m (16 kOe).

The average particle size of these particles was determined by photographing the particles with a transmission electron microscope (TEM), measuring the maximum particle size of each of the particles on the photograph (or the major axes of needle-shaped particles, or the plate sizes of plate-shaped particles), and averaging the maximum particle sizes of 100 particles to obtain a number average value.

In the magnetic recording medium (1) of the present invention, preferably, the magnetic layer (3) contains no non-magnetic particle. If needed, the magnetic layer (3) may contain a known abrasive and a known filler such as carbon black to an extension that the orientation of the magnetic particles is not disordered (1 wt. % or less of the weight of a whole of the particles). Particularly when a small amount of filler particles with such a particle size that is large enough to slightly project into the surface of the non-magnetic layer is added, the orientation of the magnetic particles is not disordered, and the surface roughness (P-V, Ra) of the uppermost non-magnetic layer is not increased. As a result, the short wavelength signal-recording performance of the magnetic recording medium is improved, and the durability thereof is greatly improved. In this regard, the use of filler particles which have shapes substantially the same as those of magnetic particles and which have sizes substantially the same as or smaller than those of the magnetic particles does not disorder the orientation of the magnetic particles, nor increases the surface roughness (P-V, Ra) of the uppermost non-magnetic layer. Thus, such filler particles may be added in an amount of 1 to 10 wt. % based on the weight of a whole of the particles. As the abrasive, each of α-alumina, β-alumina, silicon carbide, chrome oxide, cerium oxide, α-iron oxide, corundum, artificial diamond, silicon nitride, silicon carbide, titanium carbide, titanium oxide, silicon dioxide, boron nitride and the like, which has a Moh's hardness of 6 or more, may be used alone or in combination. The number-average particle size of the abrasive is preferably 10 to 200 nm.

As the carbon black, acetylene black, furnace black, thermal black or the like may be used. Preferable is carbon black with a number-average particle size of 10 to 100 nm. When it is less than 10 nm, the dispersion of carbon black becomes hard. When it exceeds 100 nm, a large amount of carbon black is needed. In either case, the surface of the magnetic layer becomes rough, which leads to a decrease in output. If needed, two or more kinds of carbon black with different number-average particle sizes may be used.

Back Layer (6)

As shown in FIG. 1 or 2, a back layer (6) may be formed on the other surface of the non-magnetic substrate (2) of the magnetic tape of the present invention (opposite to the surface of the substrate on which the magnetic layer (3) is formed) so as to improve the running performance of the tape. Generally, the back layer (6) is formed as a backcoat layer comprising non-magnetic particles and a binder resin. However, the back layer (6) may be provided in other form, as long as the above purpose can be attained. The thickness of the back layer (6) is preferably 0.2 to 0.8 μm. When it is less than 0.2 μm, the running performance-improving effect is insufficient. When it exceeds 0.8 μm, the thickness of a whole of the tape becomes larger, resulting in a less memory capacity per one reel of the tape.

Generally, the back layer contains carbon black such as acetylene black, furnace black, thermal black or the like. Usually, carbon black with a smaller particle size is used in combination with carbon black with a larger particle size. The number-average particle size of carbon black with a smaller particle size is 5 to 200 nm, preferably 10 to 100 nm. When it is less than 5 nm, the dispersion of carbon black becomes hard. When it exceeds 200 nm, a large amount of carbon black is needed. In either case, the surface of the back layer becomes rough, and such roughness of the back layer is embossed onto the magnetic layer. The use of large particle size carbon black with a number-average particle size of 200 to 400 nm in an amount of 5 to 15 wt. % based on the amount of small particle size carbon black is advantageous, because the surface of the back layer does not become rough, and because the tape-running performance-improving effect is higher. The total amount of the small particle size carbon black and the large particle size carbon black to be added is preferably 60 to 100 wt. %, more preferably 70 to 100 wt. % based on the weight of the inorganic particles.

The center line average height Ra of the back layer is preferably 3 to 8 nm, more preferably 4 to 7 nm. If the back layer (6) is magnetic, magnetic signals recorded on the magnetic recording layer, i.e., the magnetic layer (3) tend to be disturbed. Therefore, generally, the back layer (6) is non-magnetic.

The back layer (6) may contain non-magnetic plate-shaped particles with a number-average particle size of 10 to 100 nm in order to improve the strength and dimensional stability thereof against changes in temperature and humidity. As the component of the non-magnetic plate-shaped particles, not only aluminum oxide but also a rare earth element such as cerium or an oxide or compound oxide of zirconium, silicon, titanium, manganese, iron or the like are used. To improve the electric conductivity of the back layer, carbon-filled plate-shaped particles with an average particle size of 10 to 100 nm or plate-shaped ITO particles with a number-average particle size of 10 to 100 nm may be added. If needed, granular iron oxide particles with a number-average particle size of 0.1 to 0.6 μm may be further added. The amount of the non-magnetic plate-shaped particles to be added is preferably 2 to 40 wt. %, more preferably 5 to 30 wt. % based on the weight of a whole of the inorganic particles contained in the back layer (6). The addition of alumina particles with an average particle size of 0.1 to 0.6 μm is preferred, since the durability of the back layer is further improved.

The binder resin to be contained in the back layer (6) may be the same one as the resins used in the magnetic layer (3) and the primer layer (5). To reduce the friction coefficient and to improve the tape-running performance, the use of a cellulose resin in combination with a polyurethane resin as the binder resin is preferred. The content of the binder resin is generally 40 to 150 wt. parts, preferably 50 to 120 wt. parts, more preferably 60 to 110 wt. parts, still more preferably 70 to 110 wt. parts per total 100 wt. parts of the above carbon black particles and the above inorganic non-magnetic particles. When the content of the binder resin is less than 50 wt. parts, the strength of the back layer (6) is insufficient. When it exceeds 120 wt. parts, the friction coefficient tends to increase. The use of 30 to 70 wt. parts of a cellulose resin in combination with 20 to 50 wt. parts of a polyurethane resin as the binder resin is preferable. More preferably, a cross-linking agent such as a polyisocyanate compound or the like is used to cure the binder resin.

A cross-linking agent the same as those used in the magnetic layer (3) and the primer layer (5) is used in the back layer (6). The amount of the cross-linking agent is generally 10 to 50 wt. parts, preferably 10 to 35 wt. parts, more preferably 10 to 30 wt. parts per 100 wt. parts of the binder resin. When this amount is less than 10 wt. parts, the strength of the back layer (6) tends to be weak. When it exceeds 35 wt. parts, the dynamic friction coefficient of the back layer against SUS becomes larger.

A radiation-curable resin the same as those used in the magnetic layer (3) and the primer layer (5) may be added as the cross-linking agent so as to cross-link and cure the back layer (6). As the radiation-curable resin to be used in combination with the binder resin, a highly curable resin which has a double bond having a weight-average molecular weight of 50 to 300 is particularly preferable. The radiation-curable resin which has a double bond having a weight-average molecular weight of 50 to 300 is preferably in the form of a monomer. The amount of the radiation-curable resin to be added is generally 5 to 30 wt. parts, preferably 7 to 25 wt. parts, more preferably 10 to 20 wt. parts, per 100 wt. parts of the binder resin. When this amount is less than 7 wt. parts, the strength of the back layer (6) tends to be weak. When it exceeds 25 wt. parts, the friction coefficient of the back layer against SUS becomes larger.

Two or more different radiation-curable resins may be used in combination as the binder resin. In this case, preferably, a polymer type and a monomer type of different radiation-curable resins are used in combination. Preferably, the polymer type radiation-curable resin has a weight-average molecular weight of 10,000 to 100,000, and the monomer type radiation-curable resin has a weight-average molecular weight of 100 to 2,000. Preferably, the weight-average molecular weight of a double bond of the monomer type radiation-curable resin is 50 to 300.

In the present invention, the lubricant components supplied from the magnetic layer (3) and the primer layer (5) are sometimes difficult to be supplied to the surface of the tape on the side of the magnetic layer (3), since the non-magnetic layer (4) comprising a resin as the main component is formed on the magnetic layer (3). In this case, preferably, a lubricant is contained in the back layer (6), and the lubricant is supplied from the back layer (6) to the magnetic layer (3). As the lubricant, the same type of the lubricant as used in the magnetic layer (3) and the primer layer (5) is used. Preferably, 0.5 to 3.0 wt. % of a fatty acid amide, 0.2 to 3.0 wt. % of a higher fatty acid ester and 0.5 to 5.0 wt. % of a higher fatty acid are added as the lubricant, based on the weight of a whole of the non-magnetic particles in the back layer (6).

Organic Solvent

Examples of organic solvents to be used for the preparations of the coating compositions for the magnetic layer, the primer layer, the back layer and the non-magnetic layer include ketones such as methyl ethyl ketone, cyclohexanone and methyl isobutyl ketone; ethers such as tetrahydrofuran and dioxane; and acetates such as ethyl acetate and butyl acetate. Each of these solvents may be used alone or in combination, or may be further mixed with toluene or the like for use.

Effect of the Invention

According to the magnetic recording medium of the present invention, the non-magnetic layer (4) containing a resin is provided as the uppermost layer of the medium (1) on the side of the magnetic layer (3) as shown in FIG. 1 or 2, and therefore, the durability of the magnetic layer (3) is improved, which leads to the improvement of the reliability of the magnetic recording medium (1). Further, fillers such as abrasive particles and carbon black particles, which hitherto have been compounded in the conventional magnetic layers so as to improve the durability of the magnetic layers and the running performance of tapes, are not used in the magnetic layer (3), and thus, the ratio of magnetic particles filling the magnetic layer (3) can be increased, so that the magnetization per unit volume of the magnetic layer (3) can be increased. Thus, the resultant magnetic recording medium (1) is excellent in high density recording performance. While the above fillers would disorder the orientation of the magnetic particles in the conventional magnetic layers, the magnetic layer (3) of the present invention does not contain such fillers, so that the magnetic properties of the magnetic recording medium (1) can be improved, which leads to the improvement of short wavelength signal-recording performance. Further, the addition of such fillers roughens the surfaces of the conventional magnetic layers which would be formed as the uppermost layers. This is disadvantageous, because the spacing between the magnetic layer and a magnetic head unavoidably becomes larger. Whereas, in the present invention, the thin non-magnetic layer (4) is provided to cover the surface of the magnetic layer (3) so that the spacing can be decreased. By doing so, the short wavelength signal-recording performance of the magnetic recording medium can be further improved.

### EXAMPLES

Hereinafter, the present invention will be described in more detail by way of Examples thereof, which are not limit the scope of the present invention in any way. Throughout Examples and Comparative Examples, the parts indicate wt. parts, and the average particle sizes indicate number-average particle sizes, unless otherwise specified.

### Example 1

<Components of Coating Composition for Primer Layer>

| | | |
|---|---|---|
| (1) | | |
| Non-magnetic plate-shaped | 76 | parts |
| iron oxide particles | | |
| with an average particle | | |
| size of 50 nm | | |
| Carbon black with an | 24 | parts |
| average particle | | |
| size of 25 nm | | |
| Stearic acid | 2.0 | parts |
| Vinyl chloride-hydroxypropyl | 8.8 | parts |
| acrylate copolymer | | |
| containing a —SO₃Na | | |
| group (0.7 × 10⁻⁴ eq./g) | | |
| Polyester-polyurethane | 4.4 | parts |
| resin which contains | | |
| a —SO₃Na group | | |
| (1 × 10⁻⁴ eq./g) and has | | |
| a Tg of. 40° C. | | |
| Cyclohexanone | 25 | parts |
| Methyl ethyl ketone | 40 | parts |
| Toluene | 10 | parts |
| (2) | | |
| Butyl stearate | 1 | part |
| Cyclohexanone | 70 | parts |
| Methyl ethyl ketone | 50 | parts |
| Toluene | 20 | parts |
| (3) | | |
| Polyisocyanate | 1.4 | parts |
| Cyclohexanone | 10 | parts |
| Methyl ethyl ketone | 15 | parts |
| Toluene | 10 | parts |

<Components of Coating Composition for Magnetic Layer>
(1) Kneading step

As the magnetic particles, iron nitride magnetic particles prepared as follows were used.

Iron sulfate (II) heptahydrate (41.9 mol) and iron nitride (III) enneahydrate (97.4 mol) were dissolved in water (150 kg). Next, sodium hydroxide (376 mol) was dissolved in water (150 kg). To the aqueous solution of the two different iron salts was added the aqueous sodium hydroxide solution, and the mixture was stirred for 20 minutes to produce magnetite particles. The magnetite particles were charged in an autoclave and heated at 200° C. for 4 hours, and subjected to a hydrothermal treatment and then washed with water. The resultant magnetite particles had globular or ellipsoidal shapes with a particle size of 25 nm.

The magnetite particles (1 kg) were dispersed in water (50 L) for 30 minutes with a supersonic dispersing machine. To this dispersion was added yttrium nitride (250 g), and the resultant solution was stirred for 30 minutes. Separately, sodium hydroxide (80 g) was dissolved in water (10 L). This aqueous sodium hydroxide solution was added dropwise to the above dispersion over about 30 minutes. After the completion of addition, the mixture was further stirred for one hour. By this treatment, the yttrium hydroxide was coated and deposited on the surfaces of the magnetite particles. The resulting magnetite particles were washed with water, filtered and dried at 90° C. to thereby obtain the magnetite particles coated with the yttrium hydroxide.

The magnetite particles coated with the yttrium hydroxide were reduced by heating at 450° C. for 2 hours under a vapor stream to obtain yttrium-iron magnetic particles. Then, the yttrium-iron magnetic particles were heated to 150° C. over about one hour under a stream of a hydrogen gas. The hydrogen gas was replaced with an ammonia gas when the temperature had reached 150° C., and the magnetic particles were nitrided for 30 hours while the temperature was being maintained at 150° C. After that, the temperature was lowered to 90° C. under the stream of the ammonia gas, which was then replaced with a gaseous mixture of oxygen and nitrogen at 90° C. The magnetite particles were then stabilized for 2 hours under an atmosphere of the gaseous mixture. The temperature was then lowered from 90° C. to 40° C. while the gaseous mixture was being blown. The magnetite particles were maintained at 40° C. for about 10 hours, and then were removed into an air.

The contents of yttrium and nitrogen in the resultant yttrium-iron nitride magnetic particles were measured with a fluorescent X-ray spectrometer, resulting in 5.3 at. % and 10.8 at. %, respectively. A profile indicating a Fe₁₆N₂ phase was found from the X-ray diffraction pattern. From this profile, a diffraction peak derived from Fe₁₆N₂ and a diffraction peak derived from α-Fe were observed, and it was known that the yttrium-iron nitride magnetic particles comprised a mixture of the Fe₁₆N₂ phase and the α-Fe phase.

Further, the shapes of the magnetic particles were observed with a high resolution analytic transmission electron microscope, and it was found that they were substantially globular particles with an average particle size of 20 nm. The specific surface area of the magnetic particles determined according to the BET method was 53.2 m²/g. The saturation magnetization and the coercive force of the magnetic particles measured under a magnetic field of 1,270 kA/m (16 kOe) were 135.2 Am²/kg (135.2 emu/g) and 226.9 kA/m (2,850 Oe), respectively. The magnetic particles were stored at 60° C. and 90% RH for one week, and then, the saturation magnetization thereof was similarly measured. As a result, it was 118.2 Am²/kg (118.2 emu/g). The maintenance factor of the saturation magnetizations found before and after the storage was 87.4%.

| Magnetic particles (Y—Fe—N) | 100 | parts |
|---|---|---|
| (σs: 135.2 Am²/kg (135.2 | | |
| emu/g), Hc: 226.9 kA/m (2,850 Oe), | | |
| average particle size: 20 nm, | | |
| and axial ratio: 1.1) | | |
| Vinyl chloride-hydroxypropyl | 13 | parts |
| acrylate copolymer | | |
| containing a —SO₃Na | | |
| group (0.7 × 10⁻⁴ eq./g) | | |
| Polyester-polyurethane resin (PU) | 4.5 | parts |
| containing a —SO₃Na group | | |
| (1.0 × 10⁻⁴ eq./g) | | |
| Methyl acid phosphate (MAP) | 2 | parts |
| Tetrahydrofuran (THF) | 20 | parts |
| Methyl ethyl ketone/cyclohexanone (MEK/A) | 9 | parts |
| (2) Diluting step | | |
| Palmitylamide (PA) | 1.5 | parts |
| n-Butyl stearate (SB) | 1 | part |
| Methyl ethyl ketone/cyclohexanone (MEK/A) | 35 | parts |
| (3) Blending step | | |
| Polyisocyanate | 1.5 | parts |
| Methyl ethyl ketone/cyclohexanone (MEK/A) | 29 | parts |
| <Components of Coating Composition for Non-Magnetic Layer> | | |
| Organic-inorganic compound resin | 40 | parts |
| (siloxane-modified epoxy resin) (solid content) | | |
| (epoxy equivalent: 1,400 g/eq., | | |
| Si content (in terms of SiO₂): 36 wt. %) | | |
| Methyl ethyl ketone | 60 | parts |
| Polyaminoamide (amine value: 400) | 10 | parts |

The components (1) of the coating composition for a primer layer were kneaded with a batch-wise kneader, and the components (2) were added. The mixture was stirred and dispersed with a sand mill for residence time of 60 minutes. To the resultant dispersion were added the components (3), and the mixture was stirred and filtered to obtain the coating composition for the primer layer (5).

Separately, the components (1) for the kneading step were previously mixed at high speed, and the mixed particles were kneaded with a continuous twin-screw kneader, and the components (2) for the diluting step were added to the knead-mixture so as to dilute the mixture in at least two stages with the continuous twin-screw kneader. The diluted mixture was dispersed with a sand mill for residence time of 45 minutes, and the components (3) for the blending step were added. The mixture was then stirred and filtered to obtain the coating composition for the magnetic layer (3).

Further, the components for a coating composition for non-magnetic layer were stirred and mixed to obtain the coating composition for the non-magnetic layer (4).

The above coating composition for the primer layer was applied to a non-magnetic substrate (2) (a base film) composed of an aromatic polyamide film with a thickness of 3.9 μm (MICTRON manufactured by Toray Industries, Inc.; MD=11 GPa, and MD/TD=0.7), so that the resultant layer could have a thickness of 0.4 μm after dried and calendered. Thus, the primer layer (5) was formed on the non-magnetic substrate (2). The coating composition for the magnetic layer was applied to the primer layer (5) with an extrusion coater by the wet-on-wet method, so that the resultant layer could have a thickness of 40 nm after oriented in a magnetic field, dried and calendered. Thus, the magnetic layer (3) was formed. Further, the coating composition for the non-magnetic layer was applied to the magnetic layer (3) with a slide coater, so that the resultant layer could have a thickness of 8 nm after dried and calendered. Thus, the non-magnetic layer (4) was formed. Finally, the resultant magnetic sheet was oriented in a magnetic field and dried with a drier and far infrared radiation.

<Components of Coating Composition for Back Layer>

| | | |
|---|---|---|
| Carbon black | 80 | parts |
| (with an average particle size of 25 nm) | | |
| Carbon black | 10 | parts |
| (with an average particle size of 350 nm) | | |
| Non-magnetic plate-shaped iron oxide particles | 10 | parts |
| (with an average particle size of 50 nm) | | |
| Nitrocellulose | 45 | parts |
| Polyurethane resin (containing a —SO₃Na group) | 30 | parts |
| Stearic acid | 1 | part |
| Butyl stearate | 2 | parts |
| Cyclohexanone | 260 | parts |
| Toluene | 260 | parts |
| Methyl ethyl ketone | 525 | parts |

The above components of the coating composition for the back layer were dispersed with a sand mill for residence time of 45 minutes, and polyisocyanate (15 parts) was added to the dispersion to prepare the coating composition for the back layer. The coating composition was filtered, and was then applied to the other surface of the non-magnetic substrate (2) having no magnetic layer formed thereon, so that the resultant layer could have a thickness of 0.5 μm after dried and calendered. Then, the applied layer was dried.

The magnetic sheet thus obtained was planished with a seven-stage calender comprising metal rolls, at a temperature of 100° C. under a linear pressure of 196 kN/m, and was wound onto a core. The wound magnetic sheet was aged at 70° C. for 72 hours, and then was cut into tapes with widths of ½ inch.

The slitting machine (for cutting the magnetic sheet into magnetic tapes with given widths) adapted as follows was used. A tension cut roller was provided in the route for the web, extending between the sheet-unwinding position and a set of slitting blades. The tension cut roller was of mesh suction type which had sucking portions having porous metal embedded therein, and was directly connected to a motor without a mechanism for transmitting power to a blade-driving unit.

The surface of the magnetic layer of the tape cut out was polished with a lapping tape followed by a blade, and wiped, while the magnetic tape was being run at a rate of 200 m/minute. Thus, the magnetic tape was finished. As the lapping tape, K10000 was used; and as the blade, a carbide blade was used. The surface of the magnetic layer was wiped with Toraysee (trade name) manufactured by Toray Industries, Inc., under a running tension of 0.294 N. The magnetic tape thus obtained is assembled into a cartridge to make a computer tape.

### Example 2

A computer tape of Example 2 was made in the same manner as in Example 1, except that magnetic particles (Co—Fe—Al—Y) (Co/Fe: 24 at. %, Al/(Fe+Co): 4.7 wt. %, Y/(Fe+Co): Co): 7.9 at. %, σs:119 Am²/kg (119 emu/g), Hc: 181.4 kA/m (2280 Oe), average particle size: 60 nm, and axial ratio: 5) were used instead of the iron nitride magnetic particles (Y—Fe—N) (σs: 135.2 Am²/kg (135.2 emu/g), Hc: 226.9 kA/m (2850 Oe), average particle size: 20 nm, and axial ratio: 1.1), and that the thickness of the magnetic layer was changed from 0.04 μm (40 nm) to 0.06 μm (60 nm).

### Example 3

A computer tape of Example 3 was made in the same manner as in Example 2, except for the following: 1.4 parts of polyisocyanate out of the components of the coating composition for the primer layer of Example 2 was changed to 1.4 parts of dipentaerythritol hexaacrylate; 1.5 parts of polyisocyanate out of the components of the coating composition for the magnetic layer was changed to 1.5 parts of dipentaerithritol hexaacrylate; 15 parts of polyisocyanate out of the components of the coating composition for the back layer was changed to 15 parts of dipentaerythritol hexaacrylate; and the components of the coacting composition for the non-magnetic layer were changed as follows.

<Components of Coating Composition for Non-Magnetic Layer>

| | | |
|---|---|---|
| Dipentaerythritol hexaacrylate | 40 | parts |
| Methyl ethyl ketone | 60 | parts |

Further, the final thickness of the primer layer was changed from 0.4 μm to 1.2 μm; the thickness of the magnetic layer, from 0.04 μm to 0.06 μm; and the thickness of the non-magnetic layer, from 8 nm to 22 nm, and these layers were applied with an extrusion coater having three extrusion outlets. Both sides, i.e., the sides of the magnetic layer and the backcoat layer of the resultant magnetic sheet after dried were irradiated with electron beams at an exposed dose of 4 Mrad and at an acceleration voltage of 50 kV under an atmosphere of a nitrogen gas, respectively, and then were calendered. The magnetic sheet wound onto a core was not aged at 70° C. for 72 hours.

### Example 4

A compute tape of Example 4 was made in the same manner as in Example 3, except that the thickness of the magnetic layer was changed from 60 nm to 100 nm.

### Example 5

A compute tape of Example 5 was made in the same manner as in Example 3, except that the thickness of the non-magnetic layer was changed from 22 nm to 45 nm.

### Example 6

A compute tape of Example 6 was made in the same manner as in Example 4, except that the magnetic particles were changed from the magnetic particles (Co—Fe—Al—Y) (Co/Fe: 24 at. %, Al/(Fe+Co): 47 wt. %, Y/(Fe+Co): 7.9 at. %, σs: 119 Am²/kg (119 emu/g), Hc: 181.4 kA/m (2280 Oe), average particle size: 60 nm, and axial ratio: 5) to magnetic particles (Co—Fe—Al—Y) (Co/Fe: 30 at. %, Al/(Fe+Co): 4.7 wt. %, Y/(Fe+Co): 4.8 at. %, σs: 137 Am²/kg (137 emu/g), Hc: 188.6 kA/m (2370 Oe), average particle size: 100 nm, and axial ratio: 6).

### Example 7

A computer tape of Example 7 was made in the same manner as in Example 1, except for the following: the components of the coating composition for the non-magnetic layer, and the components for the kneading step for the coating composition for the magnetic layer were changed as below; the final thickness of the primer layer was changed from 0.4 μm to 1.2 μm; the thickness of the magnetic layer was changed from 40 nm to 60 nm; the thickness of the non-magnetic layer was changed from 8 nm to 25 nm; and these layers were applied with an extrusion coater having three extrusion outlets.

<Components of Coating Composition for Non-Magnetic Layer>

| Phenol resin | 40 | parts |
|---|---|---|
| (weight-average molecular weight: 8,000) | | |
| Methyl ethyl ketone | 60 | parts |
| Polyisocyanate | 10 | parts |
| <Components of Coating Composition for Magnetic Layer> | | |
| (1) Kneading step | | |
| Magnetic particles (Co—Fe—Al—Y) | 100 | parts |
| (Co/Fe: 24 at. %, Al/(Fe + Co): 4.7 wt. %, | | |
| Y/(Fe + Co): 7.9 at. %, σs: 119 Am²/kg | | |
| (119 emu/g), Hc: 181.4 kA/m (2280 Oe), | | |
| average particle size: 60 nm, and axial ratio: 5) | | |
| Vinyl chloride-hydroxypropyl acrylate copolymer | 14 | parts |
| (containing a —SO₃Na group (0.7 × 10⁻⁴ eq./g)) | | |
| Polyester-polyurethane resin (PU) | 5 | parts |
| (containing a —SO₃Na group (1.0 × 10⁻⁴ eq./g)) | | |
| Carbon black (average particle size: 75 nm) | 1 | part |
| Methyl acid phosphate (MAP) | 2 | parts |
| Tetrahydrafuran (THF) | 20 | parts |
| Methyl ethyl ketone/cyclohexanone (MEK/A) | 9 | parts |

### Example 8

A computer tape of Example 8 was made in the same manner as in Example 3, except that the components of the coating composition for the non-magnetic layer were changed as below, and that the components were dispersed with a sand mill for residence time of 45 minutes and filtered to obtain a coating composition for non-magnetic layer.

<Components of Coating Composition for Non-Magnetic Layer>

| | | |
|---|---|---|
| Dipentaerithritol hexaacrylate | 40 | parts |
| Silica aerogel | 4 | parts |
| (primary particle size: 5 nm or less) | | |
| Methyl ethyl ketone | 60 | parts |

### Example 9

A computer tape of Example 9 was made in the same manner as in Example 8, except that the silica aerogel (with a primary particle size of 5 nm or less) (4 parts) out of the components of the coating composition for the non-magnetic layer was changed to fullerene (with a primary particle size of 1 nm or less) (4 parts).

### Example 10

A computer tape of Example 10 was made in the same manner as in Example 3, except that the thickness of the magnetic layer was changed from 60 nm to 220 nm.

### Example 11

A computer tape of Example 11 was made in the same manner as in Example 3, except that the magnetic particles (Co—Fe—Al—Y) (Co/Fe: 24 at. %, Al/(Fe+Co): 4.7 wt. %, Y/(Fe+Co): 7.9 at. %, σs: 119 Am²/kg (119 emu/g), Hc: 181.4 kA/m (2280 Oe), average particle size: 60 nm, and axial ratio: 5) were changed to magnetic particles (Co—Fe—Al—Y) (Co/Fe: 30 at. %, Al/(Fe+Co): 4.7 wt. %, Y/(Fe+Co): 4.8 at. %, σs: 137 Am²/kg (137 emu/g), Hc: 188.6 kA/m (2370 Oe), average particle size: 100 nm and axial ratio: 6).

### Example 12

A computer tape of Example 12 was made in the same manner as in Example 3, except that the magnetic particles (Co—Fe—Al—Y) (Co/Fe: 24 at. %, Al/(Fe+Co): 4.7 wt. %, Y/(Fe+Co): 7.9 at. %, σs: 119 Am²/kg (119 emu/g), Hc: 181.4 kA/m (2280 Oe), average particle size: 60 nm, and axial ratio: 5) were changed to magnetic particles (Co —Fe—Al—Y) (Co/Fe: 20 at. %, Al/(Fe+Co): 4.7 wt. %, Y/(Fe+Co): 2.3 at. %, σs: 140 Am²/kg (140 emu/g), Hc: 151.6 kA/m (1950 Oe), average particle size: 110 nm, and axial ratio: 6).

### Example 13

A computer tape of Example 13 was made in the same manner as in Example 3, except that the thickness of the primer layer was changed from 1.2 μm to 0.1 μm.

### Example 14

A computer tape of Example 14 was made in the same manner as in Example 3, except that the thickness of the primer layer was changed from 1.2 μm to 1.5 μm.

### Example 15

A computer tape of Example 15 was made in the same manner as in Example 3, except that no back layer was provided.

### Comparative Example 1

A computer tape of Comparative Example 1 was made in the same manner as in Example 2, except for the following: no non-magnetic layer was provided; the components for the kneading step, out of the components of the coating composition for the magnetic layer were changed as follows; and the thickness of the primer layer was changed from 0.4 μm to 1.2 μm.

<Components of Coating Composition for Magnetic Layer>

| (1) Kneading step | | |
|---|---|---|
| Magnetic particles (Co—Fe—Al—Y) | 100 | parts |
| (Co/Fe: 30 at. %, Al/(Fe + Co): 4.7 wt. %, | | |
| Y/(Fe + Co): 4.8 at. %, σs: 137 Am²/kg | | |
| (137 emu/g), Hc: 188.6 kA/m (2370 Oe), | | |
| average particle size: 100 nm, and axial ratio: 6) | | |
| Vinyl chloride-hydroxypropyl acrylate copolymer | 13 | parts |
| (containing a —SO₃Na group (0.7 × 10⁻⁴ eq./g)) | | |
| Polyester-polyurethane resin (PU) | 4.5 | parts |
| (containing a —SO₃Na group (1.0 × 10⁻⁴ eq./g)) | | |
| Alumina particles (average particle size: 80 nm) | 8 | parts |
| Methyl acid phosphate (MAP) | 2 | parts |
| Tetrahydrafuran (THF) | 20 | parts |
| Methyl ethyl ketone/cyclohexanone (MEK/A) | 9 | parts |

### Comparative Example 2

A computer tape of Comparative Example 2 was made in the same manner as in Example 11, except that no non-magnetic magnetic layer was provided.

### Comparative Example 3

A computer tape of Comparative Example 3 was made in the same manner as in Example 6, except that the thickness of the non-magnetic layer was changed from 22 nm to 55 nm.

### Comparative Example 4

A computer tape of Comparative Example 4 was made in the same manner as in Comparative Example 1, except for the following: no primer layer was provided; the components for the kneading step, out of the components of the coating composition for the magnetic layer were changed as follows; and the thickness of the magnetic layer was changed to 2,700 nm.

<Components of Coating Composition for Magnetic Layer>

| (1) Kneading step | | |
|---|---|---|
| Magnetic particles (Ni—Fe—Al) | 100 | parts |
| (Ni/Fe: 0.5 wt. %, Al/Fe: 4.3 wt. %, | | |
| σs: 125 Am²/kg (125 emu/g), | | |
| Hc: 127.3 kA/m (1600 Oe), | | |
| average particle size: 280 nm, and axial ratio: 17) | | |
| Vinyl chloride-hydroxypropyl acrylate copolymer | 14 | parts |
| (containing a —SO₃Na group (0.7 × 10⁻⁴ eq./g)) | | |
| Polyester-polyurethane resin (PU) | 5 | parts |
| (containing a —SO₃Na group (1.0 × 10⁻⁴ eq./g)) | | |
| Alumina particles (average particle size: 80 nm) | 8 | parts |
| Carbon black (average particle size: 75 nm) | 8 | parts |
| Methyl acid phosphate (MAP) | 2 | parts |
| Tetrahydrafuran (THF) | 20 | parts |
| Methyl ethyl ketone/cyclohexanone (MEK/A) | 9 | parts |

### Comparative Example 5

A computer tape of Comparative Example 5 was made in the same manner as in Comparative Example 4, except that the alumina particles (average particle size: 80 nm) (8 parts) and the carbon black (average particle size: 75 nm) (8 parts) were not used in the magnetic layer.

### Comparative Example 6

A computer tape of Comparative Example 6 was made in the same manner as in Comparative Example 5, except that a non-magnetic layer with a thickness of 55 nm was provided.

### Comparative Example 7

A computer tape of Comparative Example 7 was made in the same manner as in Comparative Example 1, except that a top coating was formed from a solution of a mixture of a polyurethane resin (N-2034 manufactured by NIPPON POLYURETHANE INDUSTRY CO., LTD.) and stearic acid as a lubricant in the weight ratio 10:1, in a solvent mixture of toluene and methyl ethyl ketone in the ratio 4:1, in a concentration of 5 wt. %, on the magnetic layer which had been applied, dried and planished.

### Comparative Example 8

A computer tape of Comparative Example 8 was made in the same manner as in Comparative Example 4, except that a top coating was formed from a solution of a mixture of a polyurethane resin (N-2034 manufactured by NIPPON POLYURETHANE INDUSTRY CO., LTD.) and stearic acid as a lubricant in the weight ratio 10:1, in a solvent mixture of toluene and methyl ethyl ketone in the ratio 4:1, in a concentration of 5 wt. %, on the magnetic layer which had been applied, dried and planished.

The resultant magnetic tapes were evaluated as follows.

(Measurement of C/N)

A drum tester was used to measure the electromagnetic converting performance of a magnetic tape. An electromagnetic induction type head (track width: 25 μm, and gap: 0.2 μm) and a MR head (track width: 8 μm) were mounted on the drum tester so as to record data with the electromagnetic induction type head and reproduce the recorded data with the MR head. The electromagnetic induction type head and the MR head were disposed at different positions on the rotary drum, and both the heads are moved up and down to keep pace with each other in tracking. A proper length of the magnetic tape was drawn and cut from the wound magnetic tape assembled in the cartridge and scraped. Further 60 cm of the magnetic tape was cut therefrom and was further shaped into a tape strip with a width of 4 mm, which was than wound around the outer curved surface of the rotary drum.

An output and noises were evaluated as follows. A rectangular waveform signal was inputted to a recording current generator with a function generator. A signal with a wavelength of 0.2 μm was written on the magnetic tape and reproduced with the MR head. An output from the MR head was amplified with a preamplifier, and was read into a spectrum analyzer. The carrier value of 0.2 μm was defined as an output C from the medium. When a signal with a rectangular waveform of a wavelength of 0.2 μm is written, a difference obtained by subtracting an output and a system noise from the spectral component equivalent to the recording wavelength of 0.2 μm was integrated, and the resultant integrated value was used as a noise value N. The output C from the medium and the ratio C/N were compared with the values obtained from the computer tape of Comparative Example 1 to determine the relative values. In this regard, a signal with a wavelength of 1.0 μm was recorded on each of the computer tapes of Comparative Examples 4 to 6 and 8. Under this condition, the values of C and C/N were determined, and relative values were determined based on the values from the computer tape of Comparative Example 4.

<Measurement of Hc>

The magnetic properties of the magnetic tape were measured in a maximum magnetic field of 0.8 MA/m (10 kOe) with a vibrating sample magnetometer (VSM manufactured by Toei Kogyo K.K.). A hysteresis loop was drawn on a graph, and then, the characteristic values such as Mrt, Hc and SFD were determined from the hysteresis loop.

<Still Durability>

The still durability of the magnetic tape was evaluated using the drum tester, as well. The magnetic tape was set on the drum, and a carrier signal with a wavelength of 0.9 μm was similarly written on the tape. Both the heads were kept contacting the tape to continue the measurement of the output therefrom. After that, a period of time during which the output value decreased to 95% of the initial output value was defined as the still life.

<Measurement of Surface Roughness of Non-Magnetic Layer>

The roughness of the uppermost surface of the magnetic tape was measured with AFM (Dimension 3000 manufactured by Digital Instruments). The measurement was conducted in a tapping mode, and ten points in a visual field of 5 μm×5 μm (a square) were measured. From the results, the characteristic values such as a center line average height Ra, a peak-valley value P-V and the like were determined. The measured value was determined by averaging the total of the measured data from which the maximum value and the minimum value were excluded.

The results of the tests of the properties of the computer tapes of Examples are shown in Table 1, and the results of the tests of the properties of the computer tapes of Comparative Examples are shown in Table 2.

TABLE 1

| | | Example | | | | | | |
|---|---|---|---|---|---|---|---|---|
| | | 1 | 2 | 3 | 4 | 5 | 6 | 7 |
| Non- | Thickness | 8 | 8 | 22 | 22 | 45 | 22 | 25 |
| magnetic | (nm) | | | | | | | |
| layer | Component | Organic- | Organic- | EB | EB | EB | EB | Thermo- |
| | | inorganic | inorganic | resin | resin | resin | resin | curable |
| | | compound | compound | | | | | resin |
| | | resin | resin | | | | | |
| | Application | Slide | Slide | Extru- | Extru- | Extru- | Extru- | Extru- |
| | method | coater + | coater + | sion | sion | sion | sion | sion |
| | | extru- | extru- | | | | | |
| | | sion | sion | | | | | |
| Magnetic | Thickness | 40 | 60 | 60 | 100 | 60 | 100 | 60 |
| layer | (nm) | | | | | | | |
| | Magnetic | 20 | 60 | 60 | 60 | 60 | 100 | 60 |
| | particle (nm) | | | | | | | |
| | Magnetic | 226.9 | 181.4 | 181.4 | 181.4 | 181.4 | 188.6 | 181.4 |
| | particle Hc | | | | | | | |
| | (kAm) | | | | | | | |
| | Filler | None | None | None | None | None | None | Contained |
| | | | | | | | | (0.99%) |
| Primer | Thickness | 0.4 | 0.4 | 1.2 | 1.2 | 1.2 | 1.2 | 1.2 |
| layer | (μm) | | | | | | | |
| Back | Thickness | 0.5 | 0.5 | 0.5 | 0.5 | 0.5 | 0.5 | 0.5 |
| layer | (μm) | | | | | | | |
| Proper- | Hc(kA/m) | 299 | 203 | 203 | 205 | 203 | 205 | 203 |
| ties | Surface | 7 | 10 | 12 | 14 | 10 | 18 | 14 |
| | roughness of | | | | | | | |
| | uppermost | | | | | | | |
| | layer | | | | | | | |
| | P-V (nm) | | | | | | | |
| | Surface | 0.8 | 0.9 | 1.0 | 1.3 | 1.1 | 1.8 | 1.7 |
| | roughness of | | | | | | | |
| | uppermost | | | | | | | |
| | layer | | | | | | | |
| | Ra (nm) | | | | | | | |
| | C/N (dB) | 8.6 | 7.5 | 6.7 | 6.2 | 5.3 | 2.3 | 6.3 |
| | Still (min.) | 25 | 16 | 21 | 18 | 25 | 22 | 18 |

| | | Example | | | | | | | |
|---|---|---|---|---|---|---|---|---|---|
| | | 8 | 9 | 10 | 11 | 12 | 13 | 14 | 15 |
| Non- | Thickness | 22 | 22 | 22 | 22 | 22 | 22 | 22 | 22 |
| magnetic | (nm) | | | | | | | | |
| layer | Components | EB | EB | EB | EB | EB | EB | EB | EB |
| | | resin + | resin + | resin | resin | resin | resin | resin | resin |
| | | SiO₂ | fuller- | | | | | | |
| | | (5 nm) | ene | | | | | | |
| | | | (1 nm) | | | | | | |
| | Application | Extru- | Extru- | Extru- | Extru- | Extru- | Extru- | Extru- | Extru- |
| | method | sion | sion | sion | sion | sion | sion | sion | sion |
| Magnetic | Thickness | 60 | 60 | 220 | 60 | 60 | 60 | 60 | 60 |
| layer | (nm) | | | | | | | | |
| | Magnetic | 60 | 60 | 60 | 100 | 110 | 60 | 60 | 60 |
| | particle (nm) | | | | | | | | |
| | Magnetic | 181.4 | 181.4 | 181.4 | 188.6 | 151.6 | 181.4 | 181.4 | 181.4 |
| | particle Hc | | | | | | | | |
| | (kAm) | | | | | | | | |
| | Filler | None | None | None | None | None | None | None | None |
| Primer | Thickness | 1.2 | 1.2 | 1.2 | 1.2 | 1.2 | 0.1 | 1.5 | 1.2 |
| layer | (μm) | | | | | | | | |
| Back | Thickness | 0.5 | 0.5 | 0.5 | 0.5 | 0.5 | 0.5 | 0.5 | None |
| layer | (μm) | | | | | | | | |
| Proper- | Hc(kA/m) | 203 | 203 | 203 | 205 | 177 | 203 | 203 | 203 |
| ties | Surface | 16 | 15 | 13 | 18 | 20 | 15 | 13 | 12 |
| | roughness of | | | | | | | | |
| | uppermost | | | | | | | | |
| | layer | | | | | | | | |
| | P-V (nm) | | | | | | | | |
| | Surface | 1.5 | 1.4 | 1.5 | 1.7 | 2.0 | 1.2 | 1.1 | 1.1 |
| | roughness of | | | | | | | | |
| | uppermost | | | | | | | | |
| | layer | | | | | | | | |
| | Ra (nm) | | | | | | | | |
| | C/N (dB) | 6.4 | 6.5 | 5.4 | 2.7 | 2.4 | 5.8 | 6.6 | 6.0 |
| | Still (min.) | 25 | 23 | 22 | 20 | 22 | 11 | 27 | 10 |

TABLE 2

| | | Comparative Example | | | | | | | |
|---|---|---|---|---|---|---|---|---|---|
| | | 1 | 2 | 3 | 4 | 5 | 6 | 7 | 8 |
| Non- | Thickness | — | — | 55 | — | — | 55 | 20 | 20 |
| magnetic | (nm) | | | | | | | | |
| layer | Components | — | — | EB | — | — | EB | Ure- | Ure- |
| | | | | resin | | | resin | thane | thane |
| | Application | — | — | Extru- | — | — | Extru- | Top coat | Top coat |
| | method | | | sion | | | sion | | |
| Magnetic | Thickness | 60 | 60 | 100 | 2700 | 2700 | 2700 | 60 | 2700 |
| layer | (nm) | | | | | | | | |
| | Magnetic | 100 | 100 | 100 | 280 | 280 | 280 | 100 | 280 |
| | particle | | | | | | | | |
| | (nm) | | | | | | | | |
| | Magnetic | 188.6 | 188.6 | 188.6 | 127.3 | 127.3 | 127.3 | 188.6 | 127.3 |
| | particle Hc | | | | | | | | |
| | (kAm) | | | | | | | | |
| | Filler | Contained | None | None | Contained | None | None | Contained | Contained |
| Primer | Thickness | 1.2 | 1.2 | 1.2 | — | — | — | 1.2 | — |
| layer | (μm) | | | | | | | | |
| Back | Thickness | 0.5 | 0.5 | 0.5 | 0.5 | 0.5 | 0.5 | 0.5 | 0.5 |
| layer | (μm) | | | | | | | | |
| Proper- | Hc(kA/m) | 205 | 205 | 205 | 156 | 156 | 156 | 205 | 156 |
| ties | Surface | 30 | 17 | 16 | 52 | 40 | 38 | 21 | 50 |
| | roughness | | | | | | | | |
| | of | | | | | | | | |
| | uppermost | | | | | | | | |
| | layer | | | | | | | | |
| | P-V (nm) | | | | | | | | |
| | Surface | 2.8 | 1.9 | 1.5 | 4.5 | 3.5 | 3.0 | 2.2 | 4.5 |
| | roughness | | | | | | | | |
| | of | | | | | | | | |
| | uppermost | | | | | | | | |
| | layer | | | | | | | | |
| | Ra (nm) | | | | | | | | |
| | C/N (dB) | 0 | 0.8 | 0.7 | 0 | 0.8 | −0.3 | 0.2 | 0 |
| | Still | 13 | 1 | 26 | 29 | 2 | 38 | 15 | 30 |
| | (min.) | | | | | | | | |

From the results of the still durability tests of Examples 1 to 15 and Comparative Examples 2 and 5, it is 5 known that the non-magnetic layers containing the resins, formed on the uppermost layers as in Examples of the present invention, sufficiently sustain the durability of the magnetic recording media. The still values of the magnetic recording media of Examples 1 to 15 can compete with those of the magnetic recording media of Comparative Examples 1 and 4 comprising the magnetic layers which contain the fillers. Also, in this point, it is known that the non-magnetic layers formed on the uppermost layers are very significant to improve the durability of the magnetic recording media. In addition, from the comparison between the C/N values of the magnetic recording media of Example 6 and Comparative Example 3, it is confirmed that, when the thickness of the non-magnetic layer formed on the uppermost layer exceeds 50 nm, the C/N value markedly decreases, and the short wavelength signal-recording performance of the magnetic recording medium becomes poor, while other parameter values (e.g., the thickness of the magnetic layers, etc.) are the same.

Next, with reference to FIGS. 3 to 8, the critical significance of the resultant values of the present invention are elucidated. Firstly, the relationship between the thickness of the non-magnetic layer, and the still durability and the C/N value of the magnetic tape is shown in FIG. 3. In this graph, only the thickness of the non-magnetic layer was changed within a range of 0 to 60 nm, using the computer tape of Example 2 as a reference.

As is apparent from the curve indicating the still durability, the still durability is improved when the thickness of the non-magnetic layer is 1 nm or more (particularly 5 nm or more), and the still durability-improving effect is saturated when the thickness of the non-magnetic layer is 50 nm or more. While the tests are made on the non-magnetic layers with thicknesses of 8 nm or more, it is apparent that the non-magnetic layer with a thickness of 1 nm or more (particularly 5 nm or more) improves the still durability of the magnetic recording medium.

As is apparent from the curve indicating the C/N values, it is known that, when any non-magnetic layer is not formed, the evaluation of the C/N value is impossible since the still durability is very low, and that, when the thickness of the non-magnetic layer exceeds 5 nm, it becomes possible to evaluate the C/N value. The C/N value tends to decrease, as the thickness of the non-magnetic layer becomes larger. It can be confirmed, from the results of the still durability and the C/N values, that a magnetic tape having high still durability and a high C/N value can be obtained when the thickness of the non-magnetic layer is formed with a thickness of 1 to 50 nm (particularly 5 to 50 nm).

FIG. 4 shows the relationship between the resin used in the non-magnetic layer, and the still durability and the C/N value of the magnetic tape. In this graph, only the resin contained in the non-magnetic layer is changed, while the parameter values such as the thickness of the non-magnetic layer, etc. are fixed. Specifically, only the kind of the resin to be contained in the non-magnetic layer is changed as shown in FIG. 4, provided that other conditions are fixed as follows: the thickness of the non-magnetic layer is 22 nm; the thickness of the magnetic layer is 60 nm; the particle size of the magnetic particles is 60 nm (the coercive force: 181.4 kA/m); any filler is not contained in the magnetic layer; the thickness of the primer layer is 1.2 μm; and the thickness of the back layer is 0.5 μm.

It is confirmed from the graph shown in FIG. 4 that the C/N values are substantially constant independently of the kind of the resin, and that the values of the still durability are better when the EB resin (i.e., the radiation-curable resin) and the organic-inorganic compound resin are used, as compared with that of the still durability found when the thermocurable resin is used.

FIG. 5 shows the relationship between the thickness of the magnetic layer, and the still durability and the C/N value of the magnetic tape. In this graph, only the thickness of the magnetic layer is changed, while other parameter values such as the thickness of the non-magnetic layer, etc. are fixed. Specifically, only the thickness of the magnetic layer is changed within a range of 40 to 250 nm, provided that the thickness of the non-magnetic layer (containing a EB resin) is 22 nm; the size of the magnetic particles is 60 nm (the coercive force: 181.4 kA/m); any filler is not contained in the magnetic layer; the thickness of the primer layer is 1.2 μm; and the thickness of the back layer is 0.5 μm.

It is known from FIG. 5 that the still durability shows substantially constant values within the range of the tests (the thickness of the magnetic layer is changed within the range of 40 to 250 nm), and that the C/N value tends to increase as the thickness of the magnetic layer becomes smaller and that the C/N value rapidly decreases when the thickness of the magnetic layer exceeds 200 nm. It is known from the foregoing that the thickness of the magnetic layer with a thickness of 200 nm or less is preferred in order to obtain a magnetic tape having high still durability and a high C/N value, and that the thickness of the magnetic layer is preferably 10 to 200 nm (0.01 to 0.2 μm).

FIG. 6 shows the relationship between the thickness of the primer layer, and the still durability and the C/N value of the magnetic tape. In this graph, only the thickness of the primer layer is changed, while other parameter values such as the thickness of the non-magnetic layer, etc. are fixed. Specifically, only the thickness of the primer layer is changed within a range of 0.1 to 1.6 μm, provided that the thickness of the non-magnetic layer (containing a EB resin) is 22 nm; the thickness of the magnetic layer is 60 nm; the size of the magnetic particles is 60 nm (the coercive force: 181.4 kA/m); any filler is not contained in the magnetic layer; and the thickness of the back layer is 0.5 μm.

As is apparent from the graph of FIG. 6, the still durability of the magnetic tape shows a large value independently of the thickness of the primer layer, and the C/N value is as relatively small as about 3 dB when the thickness of the primer layers is 0.1 μm, however, the C/N value becomes larger when the thickness of the primer layer is 0.2 μm or more, and the C/N value is substantially constant when the thickness of the primer layer is 0.4 μm or more. The reason why the C/N value is small when the thickness of the primer layer is 0.1 μm is that the surface roughness of the uppermost layer is slightly larger. Even in this case, the C/N value is larger than the C/N value of the magnetic tape of Comparative Example 1. It is known from the above facts that the thickness of the primer layer is preferably 0.2 μm or more in order to obtain a magnetic tape having high still durability and a larger C/N value. In addition, the thickness of the primer layer of the present invention is preferably 0.2 to 1.5 μm, in consideration of the fact that the primer layer with a thickness exceeding 1.5 μm excessively increases the total thickness of the magnetic tape, which leads to a smaller memory capacity per one reel of such a magnetic tape.

FIG. 7 shows the graph indicating the relationship between the average particle size of the magnetic particles, and the still durability and the C/N values of the magnetic tape. In this graph, only the average particle size of the magnetic particles is changed while other parameter values such as the thickness of the non-magnetic layers, etc. are fixed. Specifically, only the average particle size of the magnetic particles is changed within a range of 20 to 110 nm, provided that the thickness of the non-magnetic layer (containing a EB resin) is 22 nm; the thickness of the magnetic layer is 60 nm; any filler is not contained in the magnetic layer; the thickness of the primer layer is 1.2 μm; and the thickness of the back layer is 0.5 μm. In this regard, the magnetic particles with an average particle size of 20 nm are globular particles, and the magnetic particles with other average particle sizes were needle-shaped particles, provided that the average particle sizes of the needle-shaped particles are defined as the major axes thereof.

As is apparent from the graph of FIG. 7, the still durability of the magnetic tapes shows sufficient values independently of the magnetic particle sizes, except that the still durability thereof shows a slightly smaller value when the needle-shaped magnetic particles with an average particle size of 45 nm are used, and that the still durability shows a slightly larger value when the globular magnetic particles with an average particle size of 20 nm are used. The C/N value tends to increase as the particles size of the magnetic particles becomes smaller and smaller, and the C/N value is small when the particle size of the magnetic particles exceeds 100 nm. It is known from the above facts that the average particle size of the magnetic particles is preferably 100 nm or less. It is further known that the average particle size of the magnetic particles of the present invention is preferably 5 to 100 nm, in consideration of the fact that the surface energy of the magnetic particles becomes larger, when the average particle size of the magnetic particles is less than 5 nm, which makes it hard to disperse such magnetic particles.

FIG. 8 shows the graph indicating the relationship between the surface roughness (P-V) of the non-magnetic layer, and the still durability and the C/N value of the magnetic tape. In this graph, only the surface roughness of the non-magnetic layer is changed, while other parameter values such as the thickness of the non-magnetic layer, etc. are fixed. Specifically, only the surface roughness of the non-magnetic layer is changed by forming a primer layer as follows: the primer layer is formed by changing the amount of alumina particles with an average particle size of 250 nm, while the total amount of the non-magnetic plate-shaped iron oxide particles and the alumina particles is constantly kept to be 76 parts, instead of 76 parts of the non-magnetic plate-shaped iron oxide particles with an average particle size of 50 nm used in the primer layer. In this regard, other parameters are fixed to the following: the thickness of the non-magnetic layer (containing an organic-inorganic compound resin) is 8 nm; the thickness of the magnetic layer is 40 nm; any filler is not contained in the magnetic layer; the thickness of the primer layer is 1.2 μm; the thickness of the back layer is 0.5 μm; and the magnetic particles with a particle size of 20 nm are globular particles.

As is apparent from the graph of FIG. 8, the C/N value tends to increase when the surface roughness (the P-V value) of the non-magnetic layer becomes smaller, and it is known from the experiments that the largest C/N value is obtained when the P-V value is 5 nm, and that the C/N value greatly decreases when the P-V value exceeds 20 nm. On the other hand, the still durability of the magnetic tape tends to gradually decrease when the surface roughness (the P-V value) of the non-magnetic layer becomes smaller. The experiments are made while the P-V value is being decreased to 5 nm, and it is found that the surface roughness (the P-V value) of the non-magnetic layer is preferably 2 to 20 nm, in consideration of the fact that the tape-running performance becomes unstable when the P-V value is 2 nm or less.

In the foregoing Examples, the computer tapes are made as the magnetic recording media. However, the magnetic recording media of the present invention can be provided in the forms of not only the tapes but also discs.

1. A magnetic recording medium comprising a flexible non-magnetic substrate, and a magnetic layer containing magnetic particles, formed on at least one surface of the flexible non-magnetic substrate, wherein
an uppermost layer formed on the side of the magnetic layer is a non-magnetic layer with a thickness of 1 to 50 nm, which contains a resin and has a surface roughness (P-V) of 2 to 20 nm.

2. A magnetic recording medium according to claim 1, wherein the resin contained in said non-magnetic layer contains a radiation-curable resin.

3. A magnetic recording medium according to claim 1 or 2, wherein the resin contained in said non-magnetic layer contains an organic-inorganic compound resin.

4. A process for producing a magnetic recording medium comprising a flexible non-magnetic substrate, and a magnetic layer containing magnetic particles, formed on at least one surface of the flexible non-magnetic substrate, characterized in that
said process includes a step of forming a non-magnetic layer by applying a non-magnetic coating composition on the uppermost layer formed on the side of the magnetic layer, and
said non-magnetic layer contains a resin and has a thickness of 1 to 50 nm.

5. A process according to claim 4, wherein said non-magnetic layer and said magnetic layer are formed by using at least one slide coater.
